(19) United States
(12) Patent Application Publication
(10) Pub. No.: US 2018/0034211 A1
(43) Pub. Date: Feb. 1, 2018

(54) ELECTRICAL CONNECTOR ASSEMBLY

(71) Applicant: FOXCONN INTERCONNECT TECHNOLOGY LIMITED, Grand Cayman (KY)

(72) Inventors: TERRANCE F. LITTLE, Fullerton, CA (US); JIM ZHAO, Irvine, CA (US); YUAN ZHANG, Rowland-Heights, CA (US); AN-JEN YANG, Irvine, CA (US); CHIH-HSIEN CHOU, San Jose, CA (US)

(21) Appl. No.: 15/659,634

(22) Filed: Jul. 26, 2017

Related U.S. Application Data
(60) Provisional application No. 62/367,098, filed on Jul. 26, 2016.
(60) Provisional application No. 62/399,272, filed on Sep. 23, 2016.
(60) Provisional application No. 62/412,841, filed on Oct. 26, 2016.

(51) Int. Cl. H01R 13/642; H01R 13/645; H01R 12/72

(52) U.S. Cl. CPC H01R 13/642; H01R 12/721; H01R 13/6456

(57) ABSTRACT

An electrical connector assembly includes a receptacle connector and a plug connector. The receptacle connector includes an insulative housing, and a plurality of contacts received in the housing. The plug connector includes an enclosure, and a printed circuit board enclosed in the enclosure with an end for being inserted into the insulative housing to mate with the contacts. Wherein at least one pair of slots are formed on one of the receptacle and the plug connector, and at least a corresponding pair of ribs are formed on the other to mate with the at least one pair of slots for not only providing an anti-mismating function but also a restriction function for holding the plug connector in position with respective to the receptacle.

### BACKGROUND OF THE INVENTION

### 1. Field of the Invention

The invention relates to an electrical connector assembly, and particularly to the electrical receptacle connector adapted to be mated with a plug.

### 2. Description of Related Art

Currently QSFP-DD Specification Rev. 0.1 discloses a 1×1 QSFP-DD module has eight electrical lanes. Each of the eight electrical lanes of the QSFP runs at the rate of 25 Gbit/s or 50 Gbit/s, thereby the QSFP-DD module support 200 Gbit/s or 400 Gbit/s Ethernet applications of. The QSFP-DD module has an electrical receptacle. The electrical receptacle has an insulative housing and four rows of electrical terminals received in the insulative housing. Each of the electrical terminals has a soldering section. Two rows soldering sections of the two top rows of the electrical terminals are offset in a longitudinal direction from two rows soldering sections of the two bottom rows of the electrical terminals. The present invention relates to an electrical connector assemblies, especially to the terminal layout and the terminal module assembly thereof and the so-called FP5 connector following the previous designs of which the provisional application has a Ser. No. 62/367,098 filed on Jul. 26, 2016 and another Ser. No. 62/399,272 filed on Sep. 23, 2016. As the QSFP-DD plug and receptacle has a similar interface with the FP5 plug and the receptacle. Therefore, it is need to prevent them to make a mis-mating.

An improved electrical connector assembly is desired to offer advantages over the related art.

### SUMMARY OF THE INVENTION

An object of the present invention is to provide an connector assembly having means to prevent them to make a mis-mating with other type of connector assembly.

To achieve the above-mentioned object, an electrical connector assembly comprising a receptacle connector comprising an insulative housing; and a plurality of contacts received in the housing; and a plug connector for being mated with the receptacle connector, comprising an enclosure; and a printed circuit board enclosed in the enclosure with an end for being inserted into the insulative housing to mate with the contacts; and wherein at least one pair of slots are formed on one of the receptacle and the plug connector, and at least a corresponding pair of ribs are formed on the other to mate with the at least one pair of slots for not only providing an anti-mismating function but also a restriction function for holding the plug connector in position with respective to the receptacle.

To achieve the above-mentioned object, an electrical connector assembly comprising a first electrical connector assembly including a first plug connector and a first receptacle connector adapted to be mated with each other, the first plug connector including a first cover with at least two opposite first plates defining a first receiving space with therebetween a first mating tongue in a vertical direction, the first receptacle connector including a first frame housing with therein a first mating cavity adapted to receive said first mating tongue therein; and a second electrical connector assembly including a second plug connector and a second receptacle connector adapted to be mated with each other, the second plug connector including a second cover with at least two opposite second plates defining a second receiving space with therebetween a second mating tongue in the vertical direction, the second receptacle connector including a second frame housing with therein a second mating cavity to receive the second mating tongue therein, the first receiving space being similar to the second receiving space, the first mating cavity being similar to the second mating cavity; wherein in the second connector assembly, the second cover of the second plug connector forms at least one rib on at least one of said two opposite second plates and one notch in at least one of said two opposite second plates, and the second frame housing of the second receptacle connector forms at least one slot adapted to receive said rib, and one protrusion adapted to be received within said notch during when said second plug connector and the second receptacle connector are mated with each other while the protrusion of the second receptacle connector prevents the first plug connector from being incorrectly mated therewith, and the rib of the second plug connector prevents the first receptacle connector form being incorrectly mated therewith.

Other objects, advantages and novel features of the invention will become more apparent from the following detailed description when taken in conjunction with the accompanying drawings.

### BRIEF DESCRIPTION OF THE DRAWINGS

FIG. 1(A) is a front perspective view of an electrical connector assembly including a plug connector adapted to be mated with a receptacle connector according to the first embodiment of the invention;

FIG. 1(B) is a rear perspective view of the electrical connector assembly of FIG. 1(A);

FIG. 1(C) is an elevational view of the plug connector of FIG. 1(A);

FIG. 2 is an exploded perspective view of the electrical connector assembly of FIG. 1(A) wherein the heat sink of the plug is disassembled;

FIG. 3 is a further exploded perspective view of the electrical connector assembly of FIG. 2 wherein a part of the metallic enclosure of the plug connector is removed;

FIG. 4 is a further exploded perspective view of the plug connector of FIG. 3;

FIG. 5(A) is a further front exploded perspective view of the plug connector of FIG. 4;

FIG. 5(B) is a further rear exploded perspective view of the plug connecter of FIG. 4;

FIG. 5(C) is a bottom view of a bottom half portion of the metallic enclosure of the plug connecter of FIG. 4;

FIG. 6(A) is an elevational view of one surface of the printed circuit board used within the plug connector of FIG. 2;

FIG. 6(B) is an elevational view of the surface of the printed circuit board of used within the plug connector of FIG. 2;

FIG. 6(C) is an elevational view of one surface of another embodiment of the printed circuit board used within the plug connector of FIG. 2;

FIG. 7(A) is a front perspective view of the receptacle connector of FIG. 1;

FIG. 7(B) is a rear perspective view of the receptacle connector of FIG. 1;

FIG. 8(A) is a front exploded perspective view of the receptacle connector of FIG. 7(A);

FIG. 8(B) is a rear exploded perspective view of the receptacle connector of FIG. 7(A);

FIG. 9(A) is a further front exploded perspective view of the receptacle connector of FIG. 8(A);

FIG. 9(B) is a further rear exploded perspective view of the receptacle connector of FIG. 8(A);

FIG. 10(A) is a cross-sectional view of the receptacle connector and the partial plug connector of FIG. 1 along a center line of the plug connector;

FIG. 10(B) is a cross-sectional view of the receptacle connector and the partial plug connector of FIG. 1 along a line offset from a center line of the plug connector;

FIG. 11 is a partly perspective view of the plug connector initially mated with the receptacle connector of the FIG. 1;

FIG. 12 is aside view of the plug connector of FIG. 1 with the metallic enclosure removed;

FIG. 13(A) is a front perspective view of an electrical connector assembly including a plug connector adapted to be mated with a receptacle connector according to the second embodiment of the invention;

FIG. 13(B) is a front perspective view of an electrical connector assembly including a plug connector adapted to be mated with a receptacle connector according to the first embodiment of the invention with a differently shaped EMI shielding block;

FIG. 14(A) is a front perspective view of the electrical connector assembly of FIG. 13(A) wherein the plug cable connector is removed from the receptacle connector;

FIG. 14(B) is a front perspective view of the electrical connector assembly of FIG. 13(B) wherein the plug cable connector is removed from the receptacle connector;

FIG. 15(A) is a perspective view of the EMI shielding block of the plug cable connector of FIG. 13(A);

FIG. 15(B) is a perspective view of the EMI shielding block of the plug cable connector of FIG. 13(B);

FIG. 15(C) is another perspective view of the EMI shielding block of the plug cable connector of FIG. 13(B);

FIG. 16 is a perspective view of the plug cable connector with the EMI shielding block is removed away from the housing of the plug cable connector of FIG. 13(B);

FIG. 17 is a further exploded perspective view of the plug cable connector of FIG. 16;

FIG. 18 is a perspective view of an electrical connector assembly according to a third embodiment of the invention;

FIG. 19 is a perspective view of the electrical connector assembly of FIG. 18 wherein the cage enclosing the receptacle connector is removed;

FIG. 20 is a perspective view of the electrical connector assembly of FIG. 19 wherein the plug cable connector is mated with the receptacle connector;

FIG. 21(A) is a downward front perspective view of the plug cable connector of FIG. 20 wherein the upper molded floating housing is removed therefrom;

FIG. 21(B) is an upward front perspective view of the plug cable connector of FIG. 21(A);

FIG. 22(A) is a downward exploded perspective view of the plug cable connector of FIG. 21(A);

FIG. 22(B) is an upward exploded perspective view of the plug cable connector of FIG. 22(A);

FIG. 23(A) is a downward front perspective view of the housing of the plug cable connector of FIG. 22(A) with the upper fixed housing and the upper floating housing removed therefrom;

FIG. 23(B) is a downward rear perspective view of the housing of the plug cable connector of FIG. 22(A) with the upper fixed housing and the upper floating housing removed therefrom;

FIG. 24 is a downward front perspective view of the housing and the printed circuit board of FIG. 23(A) with the upper fixed housing and the upper floating housing removed therefrom;

FIG. 25 is a downward rear perspective view of the housing with the printed circuit board of FIG. 24 with the upper fixed housing and the upper floating housing removed therefrom;

FIG. 26(A) is a top view of a printed circuit board assembly during manufacturing wherein each printed circuit board is used within the plug cable connector of FIG. 18;

FIG. 26(B) is a bottom view of a printed circuit board assembly of FIG. 26(A);

FIG. 27(A) is an illustrative view to show mating between the printed circuit board and the receptacle connector;

FIG. 27(B) is another illustrative view to show the mating between the printed circuit board and the receptacle connector;

FIG. 28 is a across-sectional view, taken along a center vertical plane in the front-to-back direction, of the mated plug cable connector and receptacle connector of the electrical connector assembly of FIG. 18;

FIG. 29 is a cross-sectional view, taken along a transverse vertical plane, of the plug cable connector of FIG. 18;

FIG. 30 is another across-sectional view, taken along another transverse vertical plane, of the plug cable connector of FIG. 18;

FIG. 31(A) is a front downward perspective view of the receptacle connector used with the plug cable connector of FIG. 18 according to another embodiment of the invention;

FIG. 31(B) is a rear upward perspective view of the receptacle connector of FIG. 31(A);

FIG. 32 is a perspective view of an electrical connector assembly according to a fourth embodiment of the invention;

FIGS. 33 is a perspective view of the electrical connector assembly of FIG. 32 with the cage removed therefrom;

FIGS. 34 is another perspective view of the electrical connector assembly of FIG. 33;

FIGS. 35 is a perspective view of the electrical connector assembly of FIG. 32 with the plug connector initial alignment with the receptacle connector;

FIGS. 36 is a perspective view of the electrical connector assembly of FIG. 32 with the plug connector final alignment with the receptacle connector;

FIGS. 37 is a front downward perspective view of the receptacle connector used with the plug cable connector of FIG. 32;

FIGS. 38 is a rear upward perspective view of the receptacle connector of FIG. 37;

FIG. 39(A) is a perspective view of an electrical connector assembly named FP5 according to a fifth embodiment of the invention;

FIG. 39(B) is another perspective view of the electrical connector assembly of FIG. 39(A);

FIG. 40 is an assembled perspective view of the electrical connector assembly of FIG. 39(A);

FIG. 41 is an exploded perspective view of the electrical connector assembly of FIG. 40;

FIG. 42(A) is a front downward perspective view of the electrical receptacle of FIG. 41;

FIG. 42(B) is a rear downward perspective view of the electrical receptacle of FIG. 42(A);

FIG. 42(C) is a rear upward perspective view of the electrical receptacle of FIG. 42(A);

FIG. 43 is an exploded perspective view of the plug connector of FIG. 41;

FIG. 44(A) is a front further exploded perspective view of the plug connector of FIG. 43;

FIG. 44(B) is a rear exploded perspective view of the plug connector of FIG. 43;

FIG. 45 is an exploded perspective view of the cage and the electrical receptacle of FIG. 41;

FIG. 46 is a top view of the plug connector without the top cover of FIG. 41; and

FIG. 47 is a cross-sectional view of the assembled electrical connector assembly of FIG. 40.

### DETAILED DESCRIPTION OF THE PREFERRED EMBODIMENT

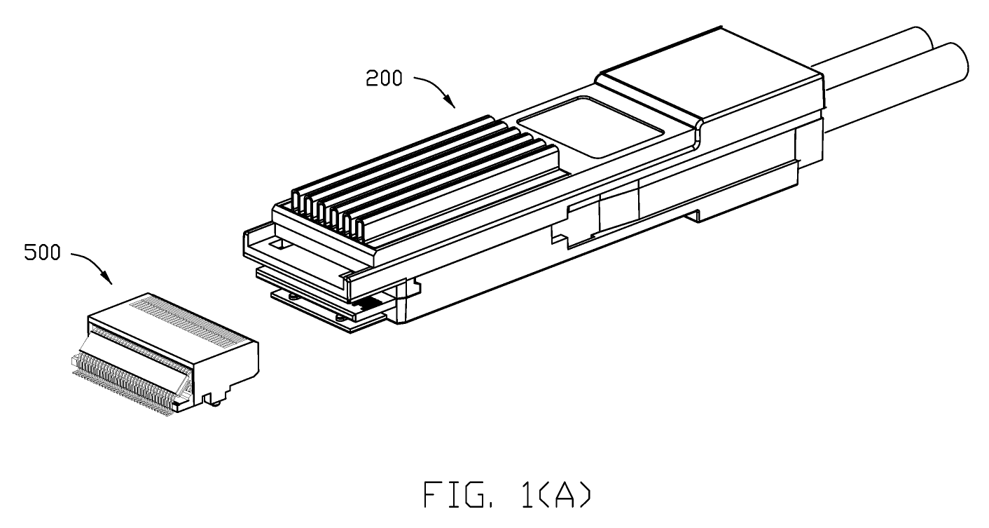

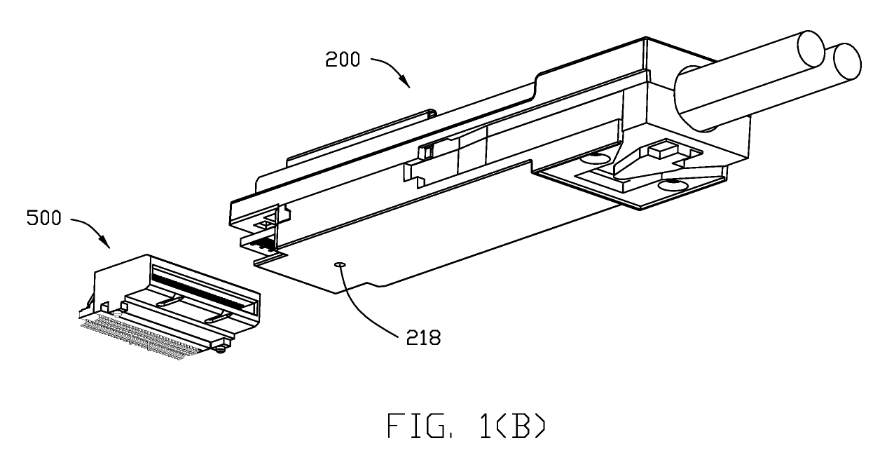

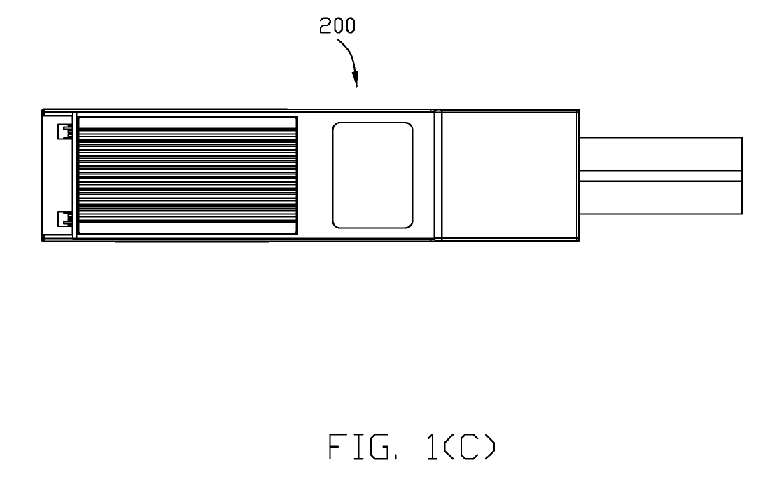

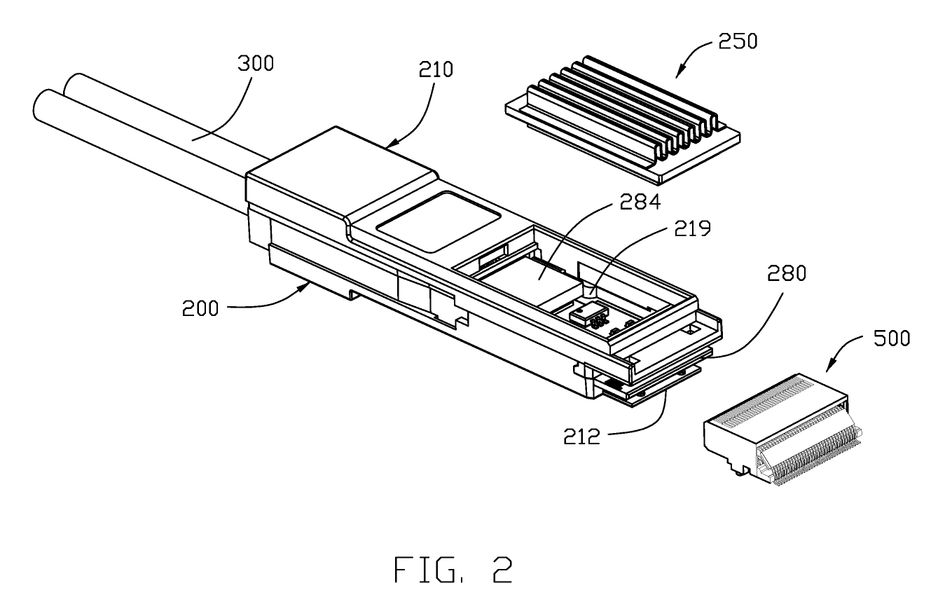

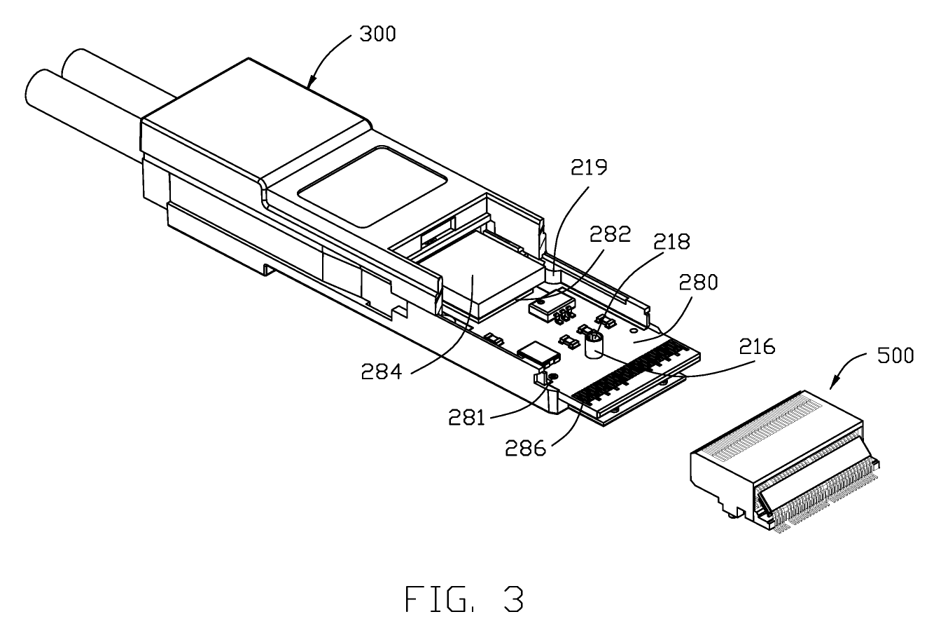

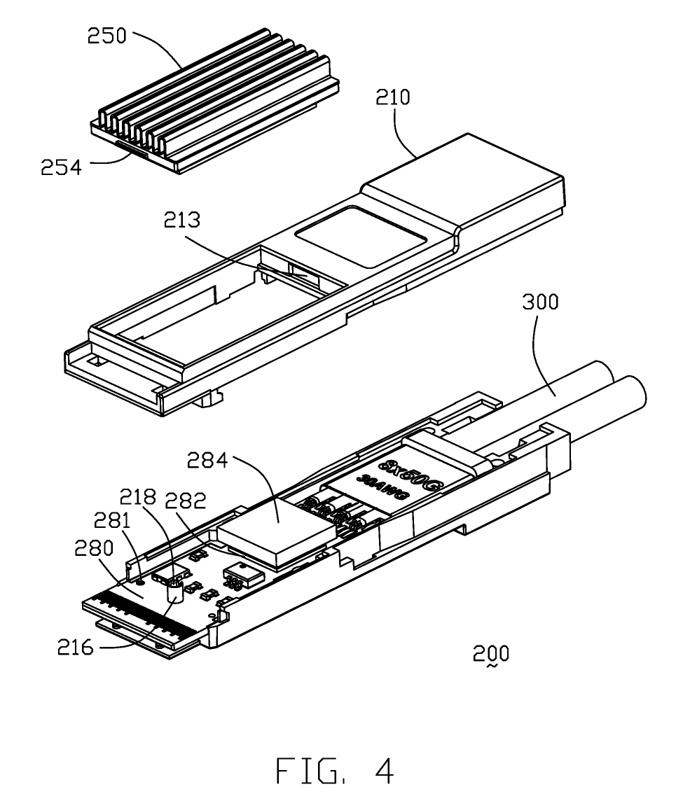

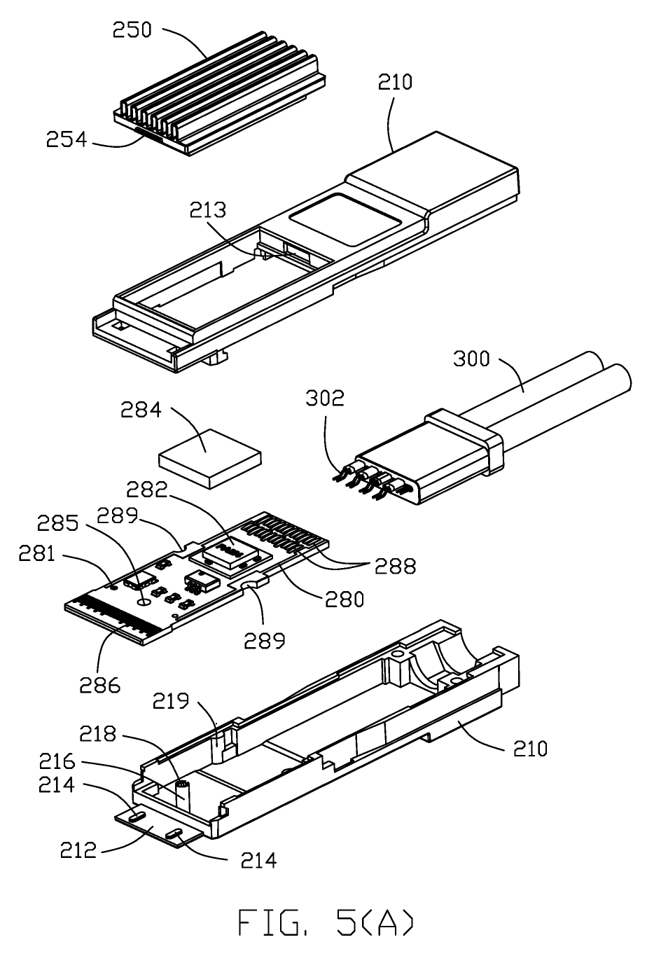

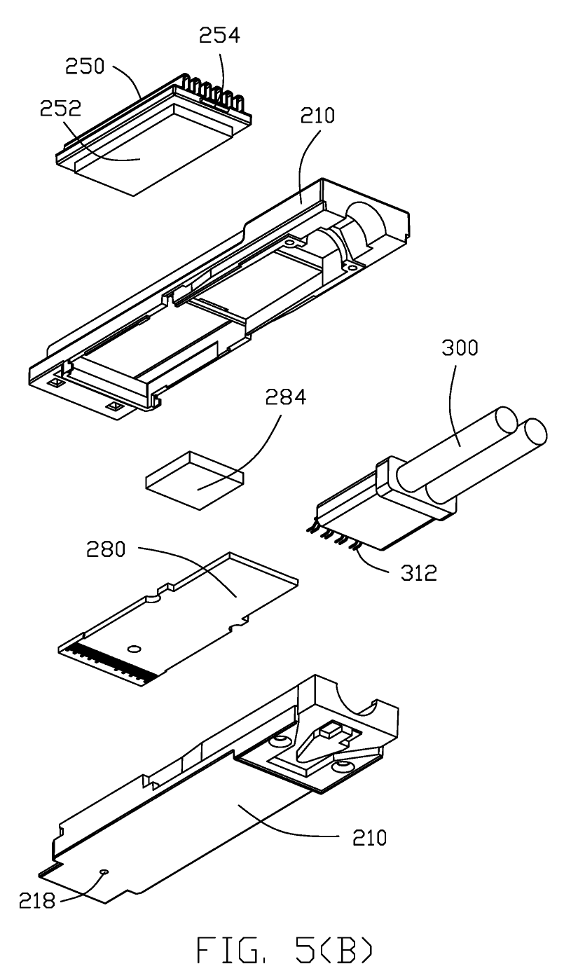

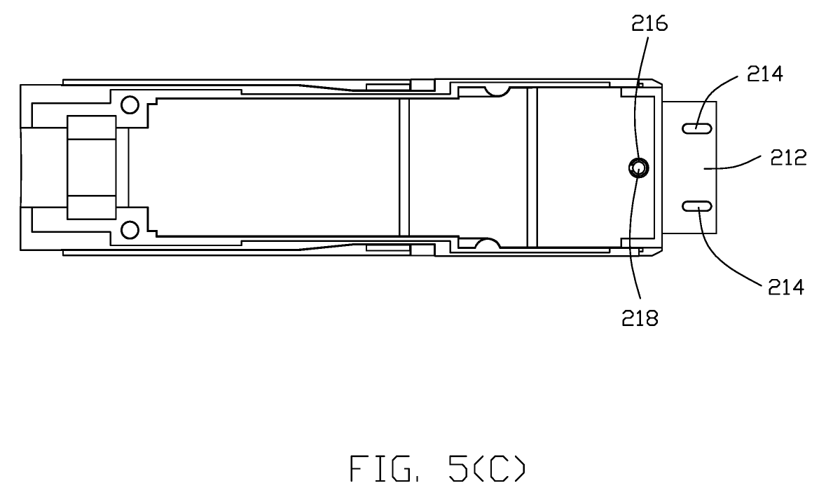

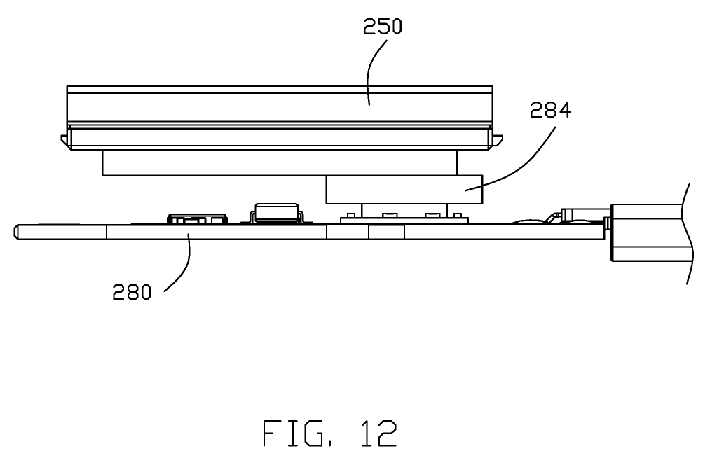

Referring to FIGS. 1-6(B) and 12, a first embodiment of the invention includes a cable connector or plug connector 200 mated with a receptacle connector 500 adapted mounted upon a printed circuit board (not shown). The cable connector 200 includes a metallic enclosure 210 with a detachably attached heat sink 250 to enclose a printed circuit board 280 with electronic components 282 thereon wherein the enclosure 210 includes upper and lower parts assembled to each other in the vertical direction. In this embodiment, the heat sink 250 includes associatively a thermal pad 252 thereunder. A thermal block 284 is sandwiched between the electronic component 282 and the heat sink 250 to dissipate heat from the electronic component 282 to the heat sink structure 250. Notably, the thermal pad 252 and the thermal block 284 are of the same character so as to be deemed as one piece. A plurality of pads 286 are formed on a front region of the printed circuit board 280 in one row with a 0.5 mm pitch, compared with the pads in two rows with a 0.8 mm pitch used in QSFP-DD version. A plurality of pads 288 formed on a rear region of the printed circuit board 280 in two rows. A cable 300 includes a plurality of differential wires 302 soldered upon the corresponding pads 288. The printed circuit board 280 forms a pair of side notches 289 for engagement with the corresponding side posts 219 on an interior surface of the enclosure 210.

Compared with the previous design, there are some other features in the instant invention. The conductive pads 286 are arranged in one row in a 0.5 mm pitch. 0.5 mm pitch PCB contact to pad true position must be tightly controlled in order to maintain adequate functionality. To assure the precise position of those conductive pads 286, a pair of fiducial positions 281 are defined in the printed circuit board 280 for easy reference. It is noted that the width dimension of the instant invention is same with the traditional QSFP and QSFP-DD. Therefore, for not interchanging with those two other type connectors, in the instant invention a front end of the metallic enclosure 210 further includes an additional plate 212 with a pair of ribs 214 thereon for coupling to the corresponding slots in the receptacle connector illustrated later. To facilitate heat dissipation, a hollow column structure 216 is unitarily extends inwardly/vertically in the enclosure 210 for providing an air intake hole 218 therein and through a through hole 285 in the printed circuit board 280 so as to communicate the exterior air with the interior air in the enclosure 210. The through hole 285 of the printed circuit board 280 is accurately drilled.

In this embodiment, the heat sink 250 is detachably attached to the enclosure 210 in a rotational manner wherein the heat sink 250 includes the latching structure 254 and the enclosure 210 includes the recess structure 213. Notably, the drawings shown in this embodiment in FIGS. 1-6(B) does not completely show the detailed structure regarding the interengagement structures about the heat sink 250 and the enclosure 210. Understandably, it may require some deformable/deflectable/removable structures thereabouts for performing removability thereof.

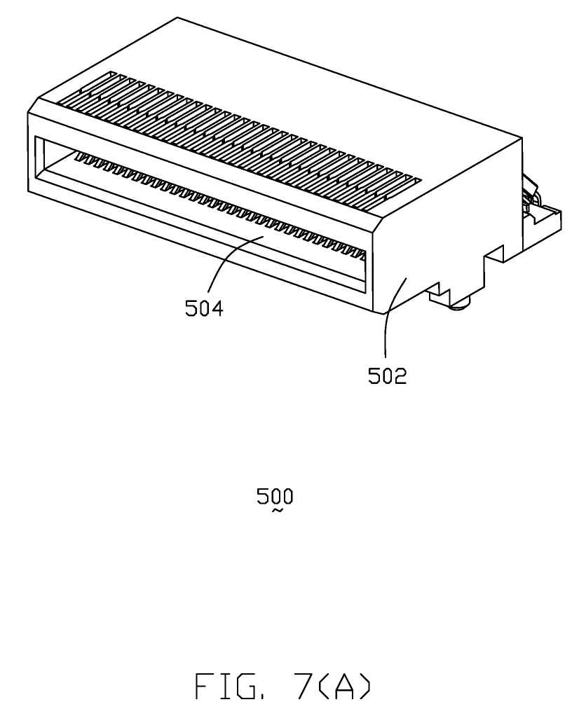

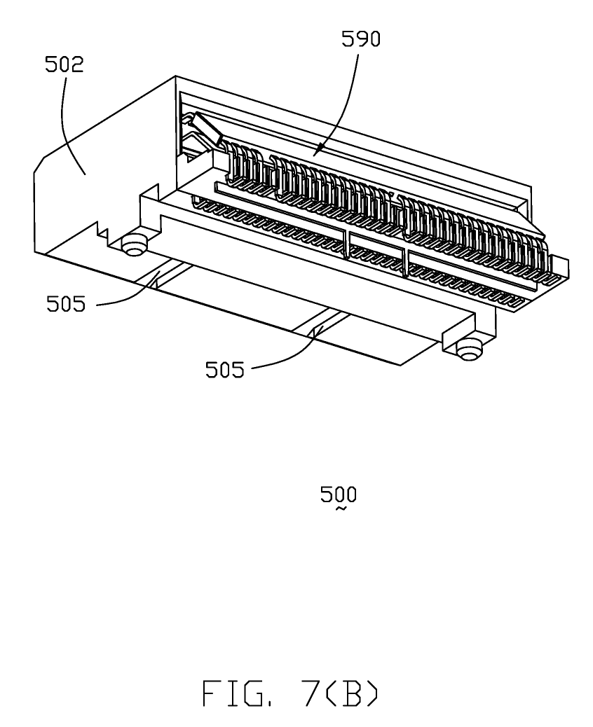

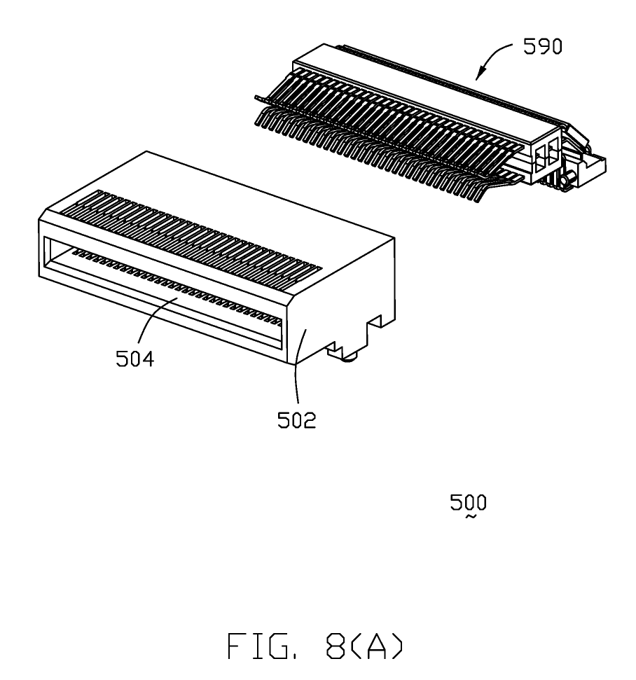

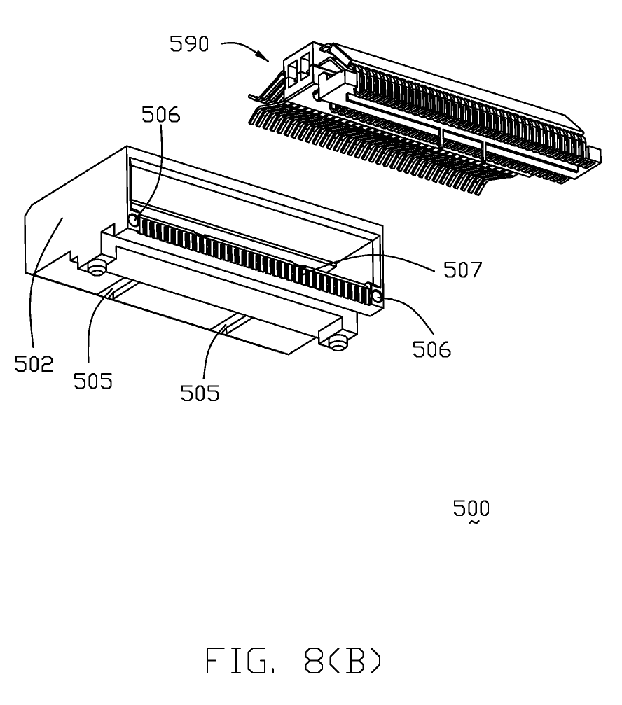

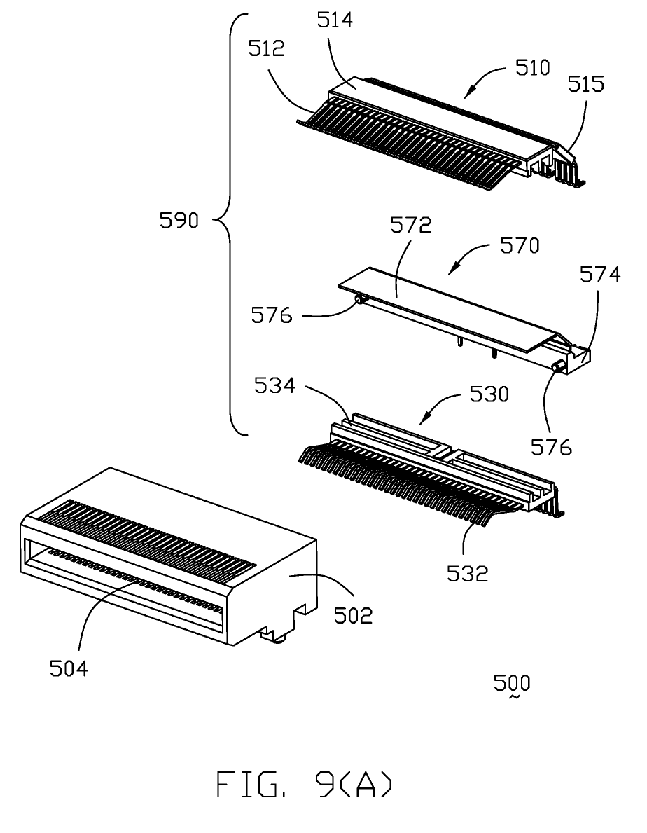

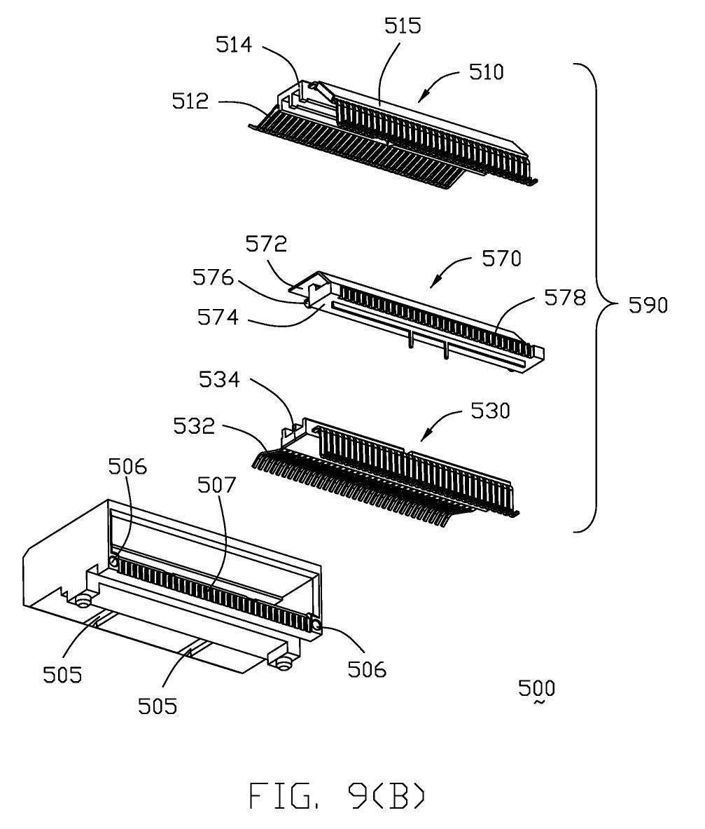

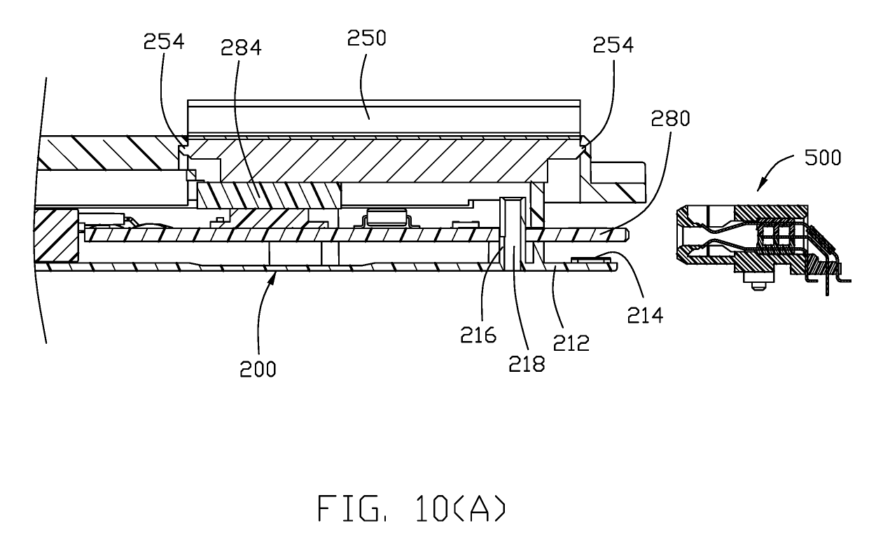

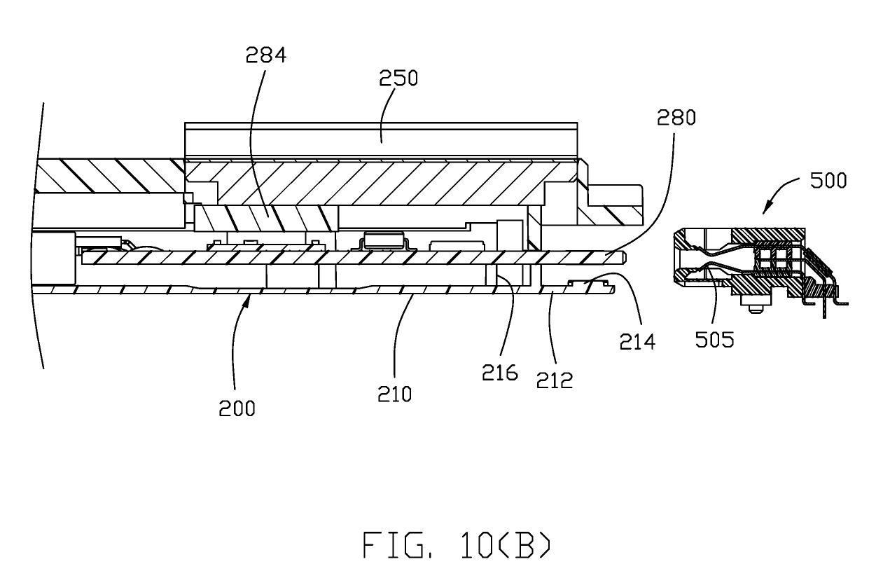

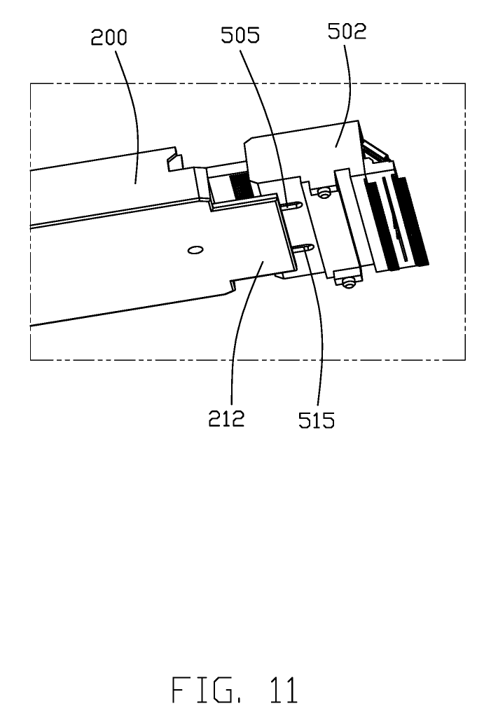

As shown in FIGS. 7(A)-11, the receptacle connector 500 includes an insulative housing 502 forming a mating cavity 504 to receive the front region of the printed circuit board 280 therein. A terminal module assembly 590 includes an upper terminal module 510 and a lower terminal module 530 stacked with each other with a shielding plate module 570 therebetween in a vertical direction and commonly received within the housing 502. The upper terminal module 510 includes a plurality of upper terminals 512 retained in an upper insulator 514 and an upper rear insulator 515; the lower terminal module 530 includes a plurality of lower terminals 532 retained in a lower insulator 534; and the shielding plate module 570 includes a metallic shielding plate 572 retained in a lower rear insulator 574. The lower rear insulator 574 includes a pair of positioning posts 576 to be inserted into the corresponding positioning holes 506 of the insulative housing 502. A plurality of grooves 578 are formed in the rear side of the lower rear insulator 574 to receive the tail sections of the corresponding upper terminal 512. Similarly, the rear side of the insulative housing 502 forms a plurality of grooves 507 to receive the tail sections of the corresponding lower terminals 532. Understandably, the upper terminal module 510, the lower terminal module 530 and the shielding plate module 570 may be equipped with pre-assembling or vertically aligning structures to pre-assemble the whole terminal module 590 and simultaneously insert the whole terminal module 590 into the insulative housing 502 instead of assembling in a sequence of the lower terminal module 530, the shielding plate module 570 and the upper terminal module 510.

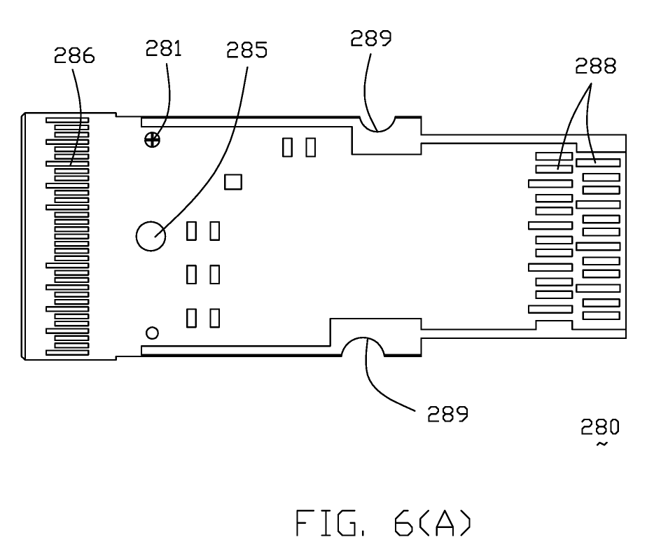

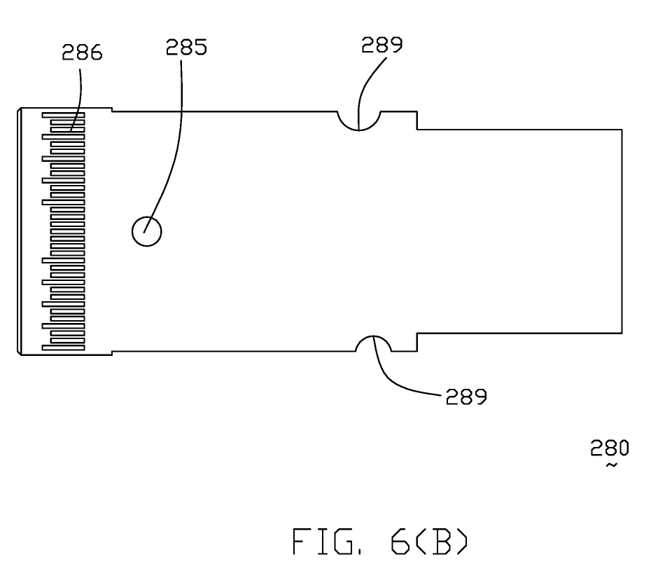

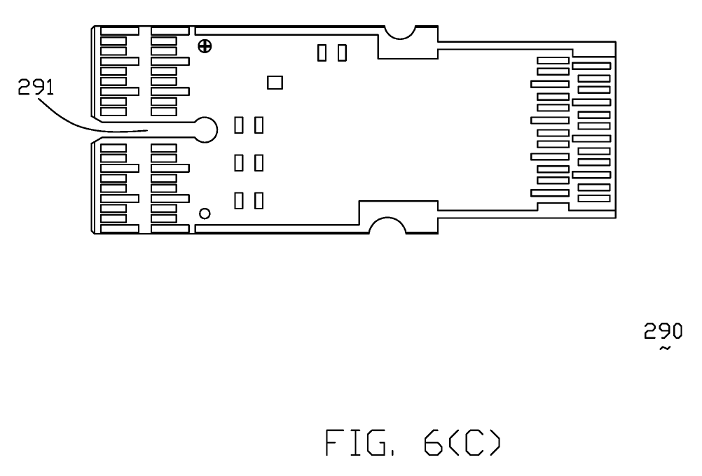

Compared with the previous design, in the instant invention the receptacle connector 500 provides a pair of alignment slots 505 to receive the corresponding ribs 214 on the plug connector 200. In this arrangement, the plug connector 200 can be inserted into the corresponding receptacle connector 500 while can not be inserted into the similar receptacle connector lacking such alignment slots as the so-called QSFP-DD receptacle connector Understandably, to further prevent the QSFP-DD plug connector from being inserted into the receptacle connector 500, in another embodiment (detail can be see in the fourth embodiment) the receptacle connector 500 may need to form an addition protrusion and the plug connector 200 may need to form a corresponding recess to receive such a protrusion therein. Notably, FIG. 6(C) shows another embodiment of the printed circuit board 290 of the plug connector forms a slot 291 and the corresponding receptacle connector 200 forms a ribbed structure (not shown) in the mating cavity to mate therewith. Therefore, the QSFP-DD plug connector can not be inserted into the receptacle connector due to such an additional protrusion. This mutual prevention between two similar interfaces of the connector assembly may also be referred to the copending application Ser. No. 14/839,880 filed Aug. 28, 2015.

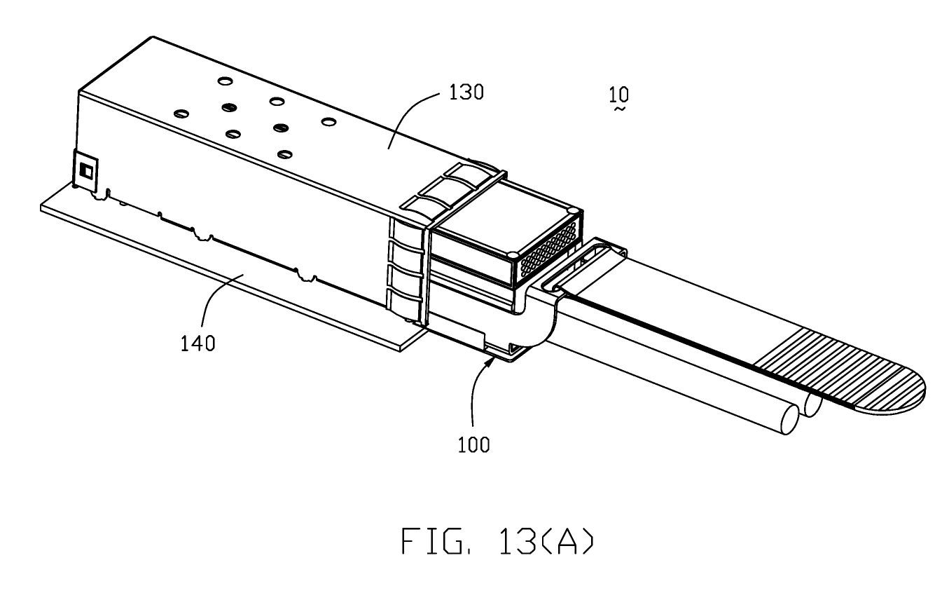

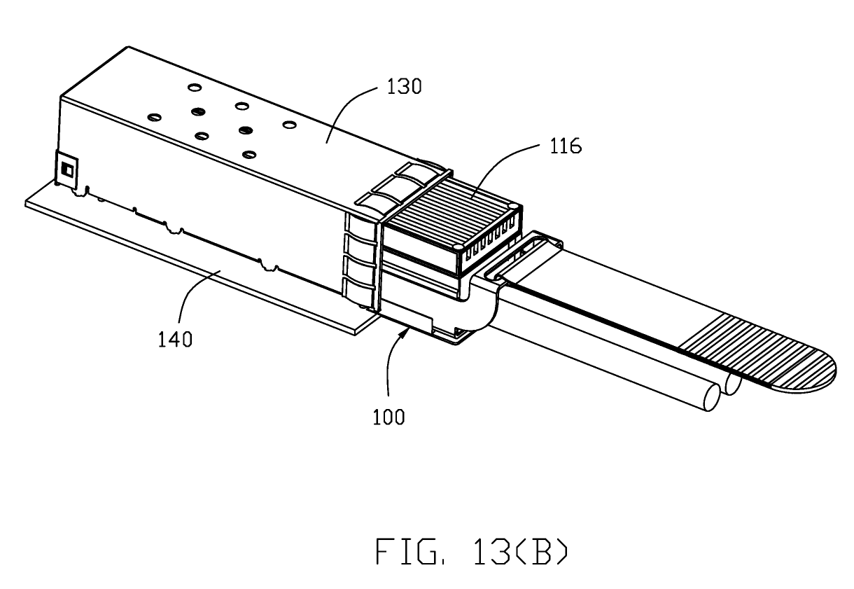

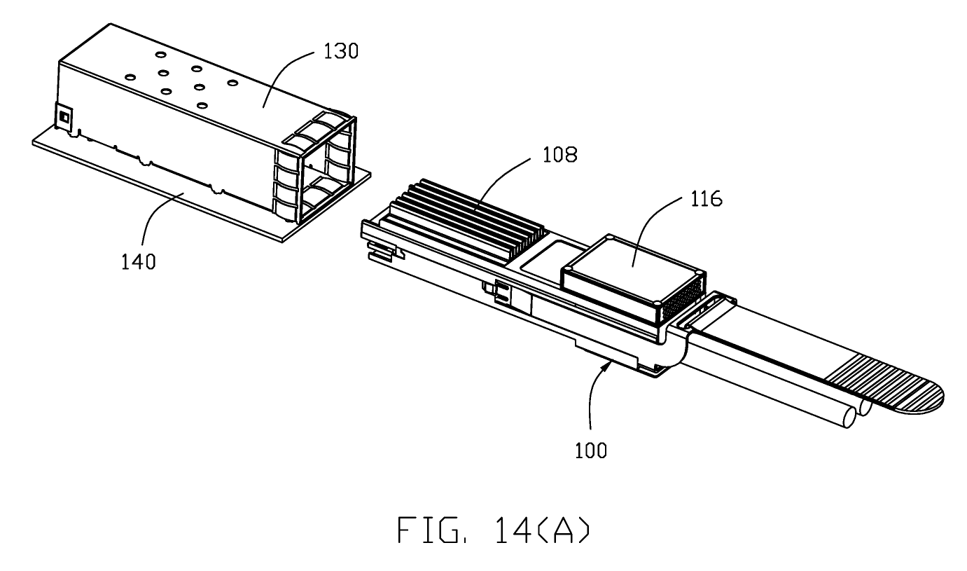

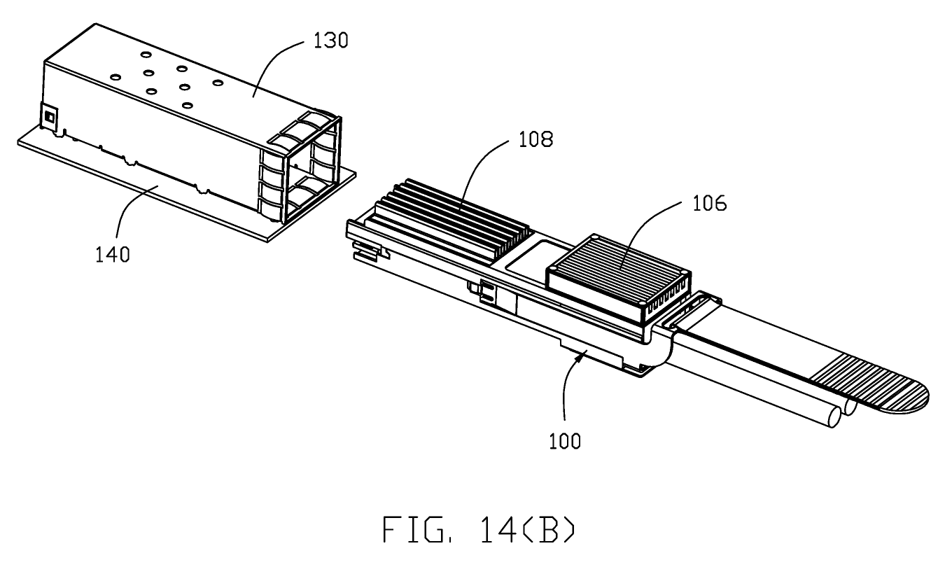

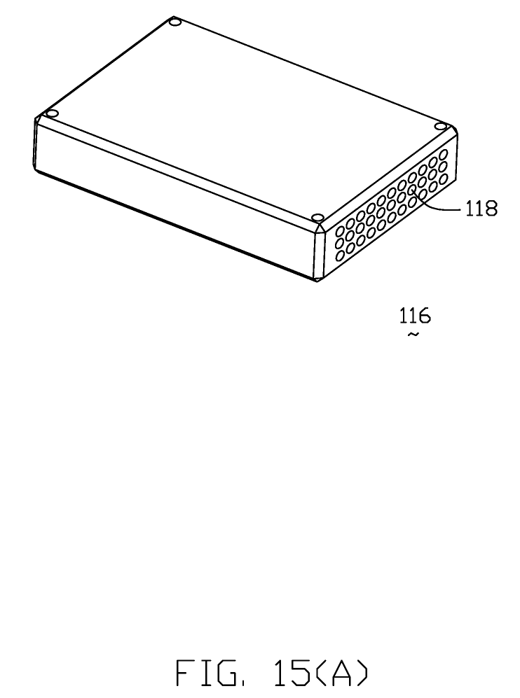

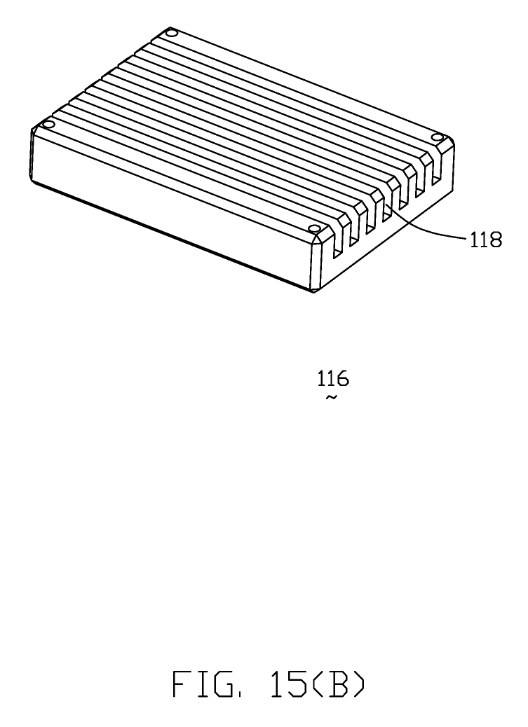

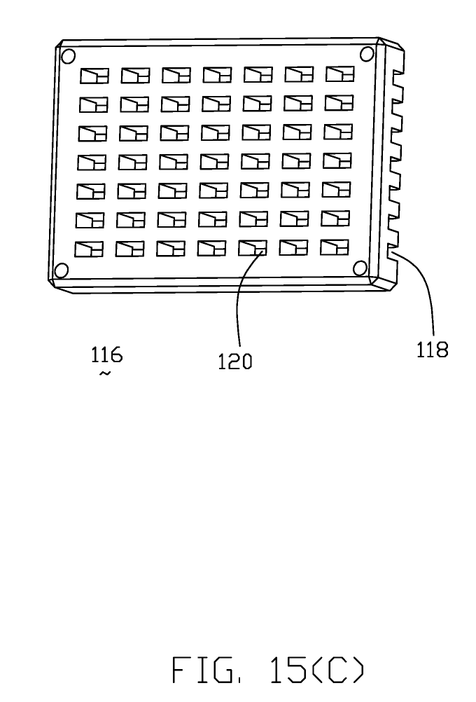

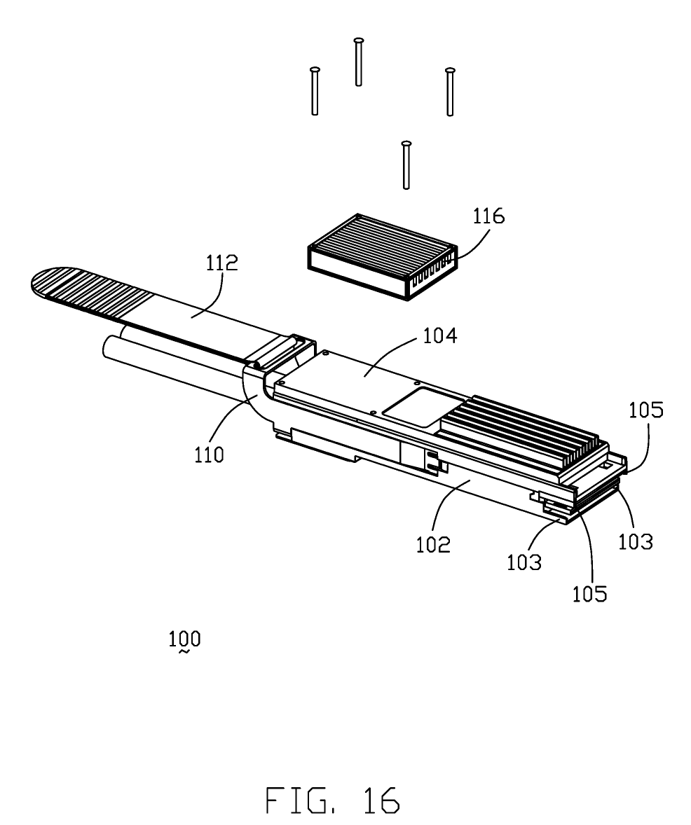

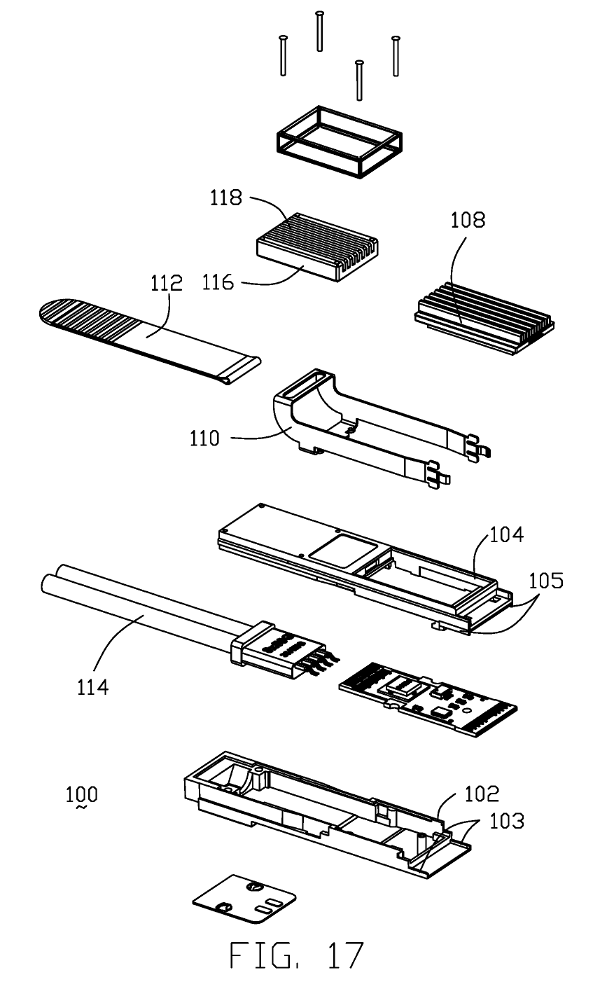

Referring to FIGS. 13(A)-17, a second embodiment of the invention electrical connector assembly 10 includes a plug cable connector 100 and a receptacle connector (not shown in this embodiment while being shown in the third embody) enclosed within a metallic cage 130 and mounted upon a mother board 140. The basic structures of the plug cable connector and those of the receptacle connector may be referred to aforementioned previously filed provisional application wherein the plug cable connector 100 includes s lower metallic die cast housing 102, an upper metallic die cast housing 104 sandwiching a printed circuit board 106 therebetween in the vertical direction. A replaceble heat sink 108 is removably attached upon the upper housing 104. An actuator 110 and the corresponding pulling tape 112 are associatively assembled upon at least one of the lower housing 102 and the upper housing 104. A cable 114 is connected to a rear end portion of the printed circuit board 106 while the front end portion of the printed circuit board is located in a front portion of the upper housing 104 and the lower housing 102 and functioning as a mating tongue. Different from the previous design, a pair of ribs 103 are formed on two opposite lateral side of the lower housing 102 and a pair of ribs 105 are formed on two opposite lateral side of the upper housing 104 for coupling to the corresponding four slots 602 formed at four corners of the insulative housing 610 of the receptacle connector 600, which are not shown in this embodiment while being shown in the third embody. Through this rib-slot arrangement, the plug cable connector only mates with the correct receptacle connector while being unable to mate with a similar receptacle connector having a similar interface configuration with the receptacle connector while without the corresponding slots at four corners. This anti-mismating structure is analogous to the anti-mismating structure disclosed in the aforementioned previously filed provisional application for preventing the instant plug cable connector from being mated with the QSFP-DD receptacle connector. An EMI shielding block 116, which is essentially made of molded conductive plastic, is intimately mounted upon the upper housing 104 behind the heat sink 108 for radiation absorption consideration. The upper face of the EMI shielding block 116 contacts the metal cage 300 and the bottom face of the EMI shielding block 116 contacts the upper surface of the upper housing 104. A plurality of passageways 118 extend through the EMI shielding block 116 in a front-to-back direction, and a plurality of through holes 120 extend through the EMI shielding block 116 in the vertical direction to allow air passing for heat transfer.

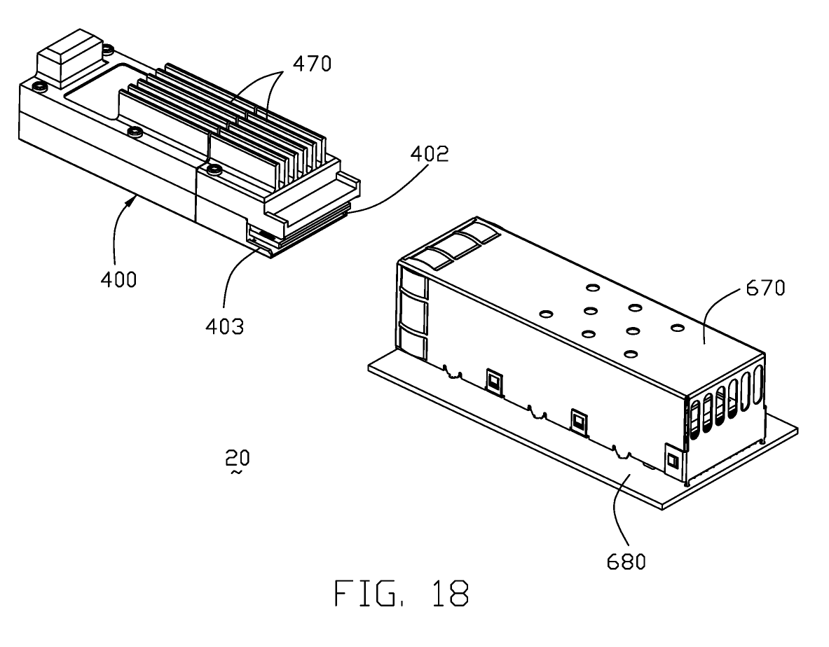

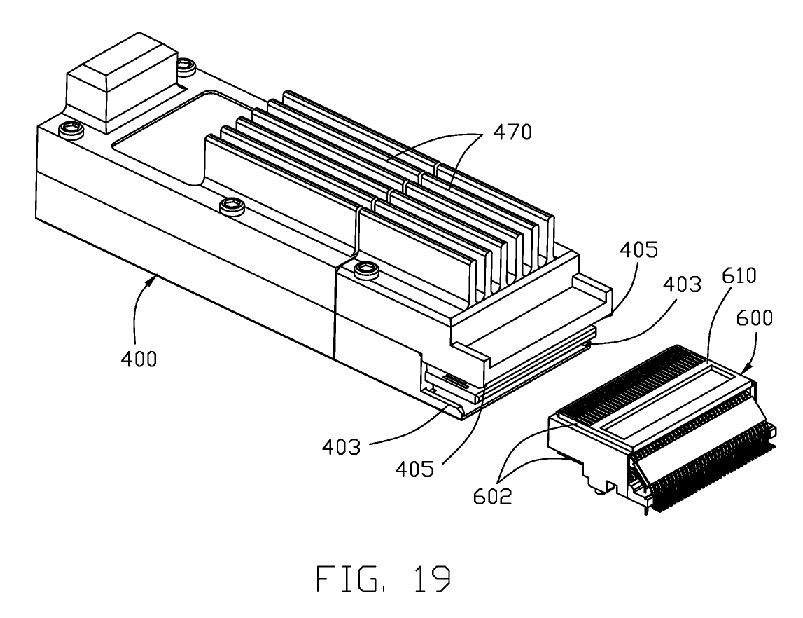

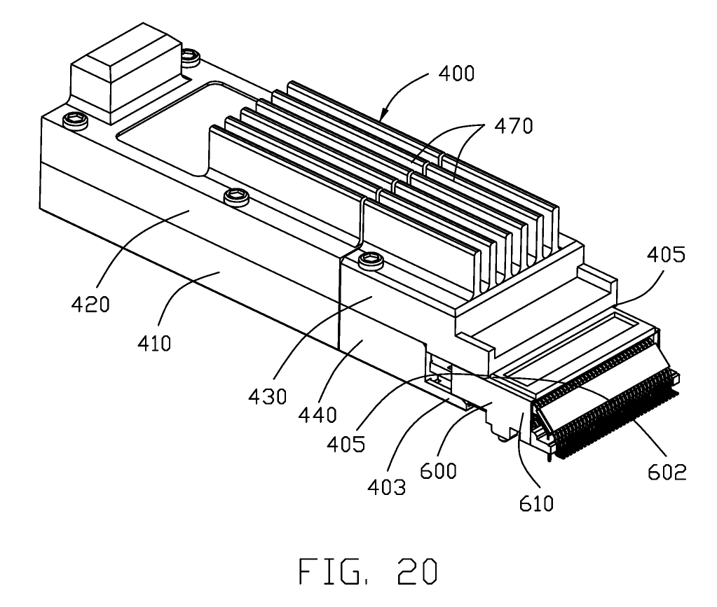

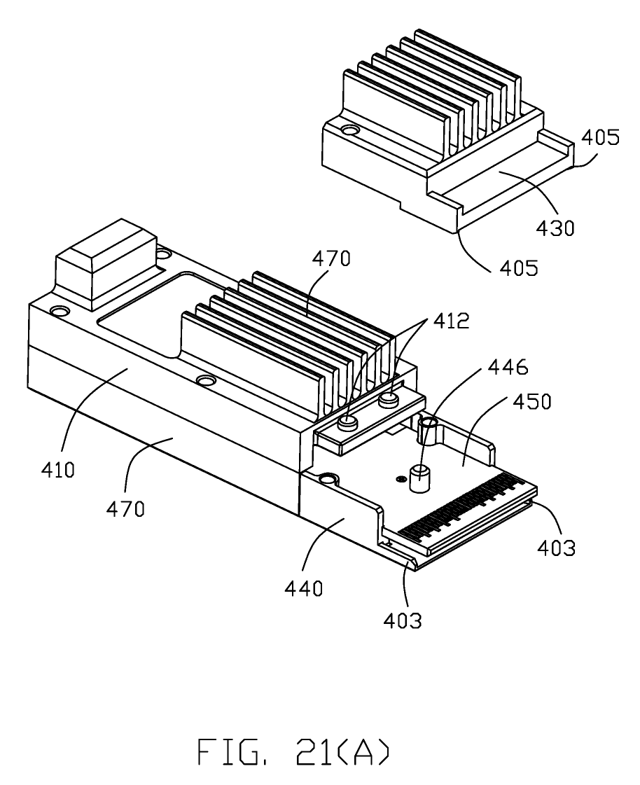

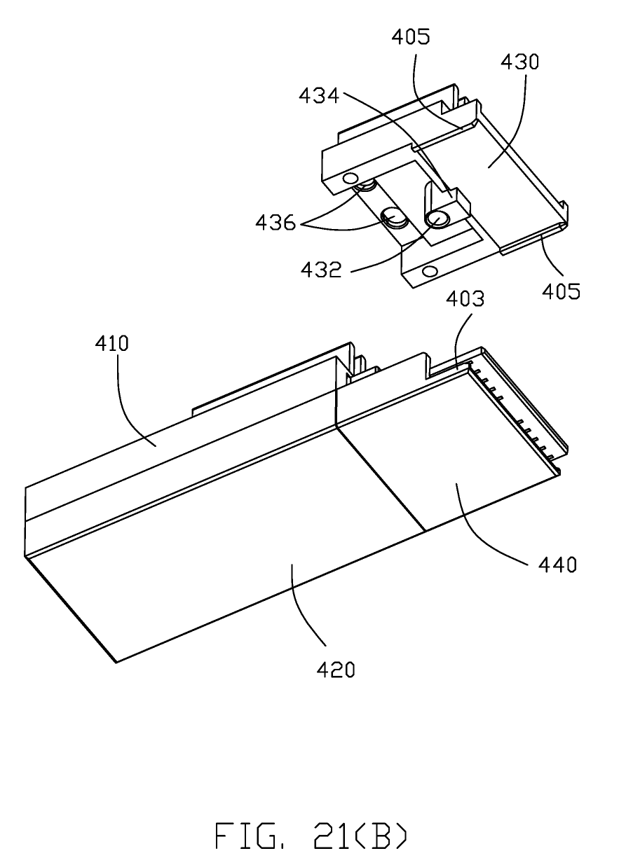

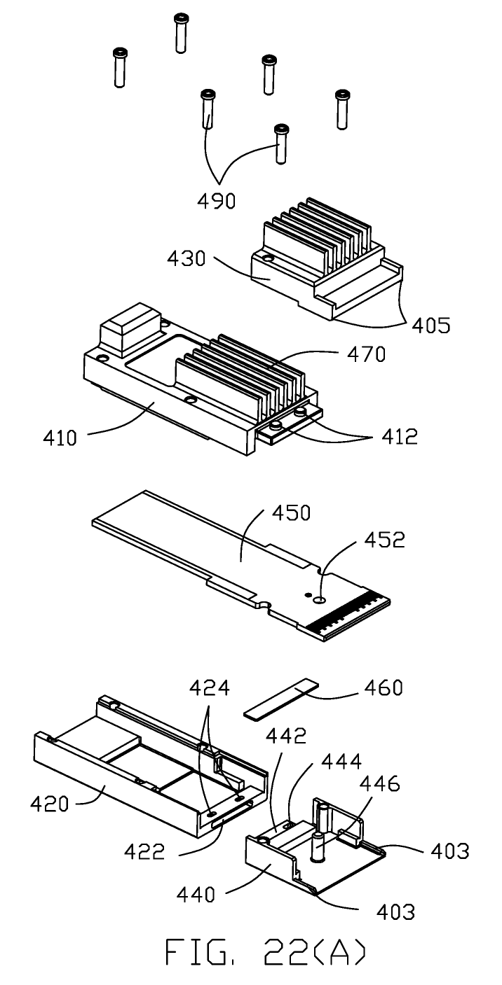

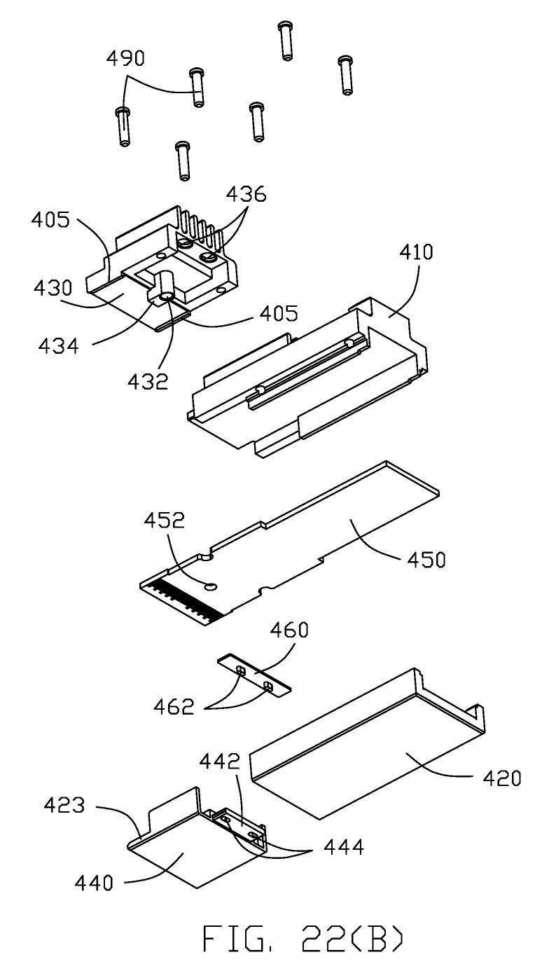

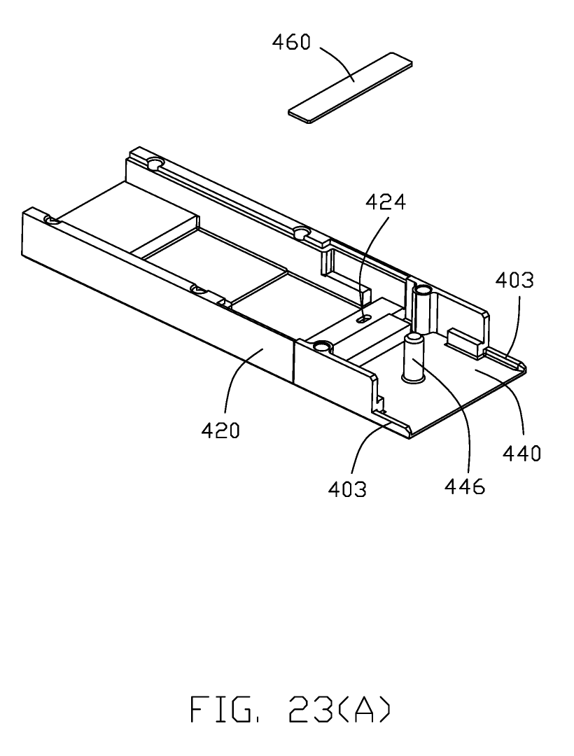

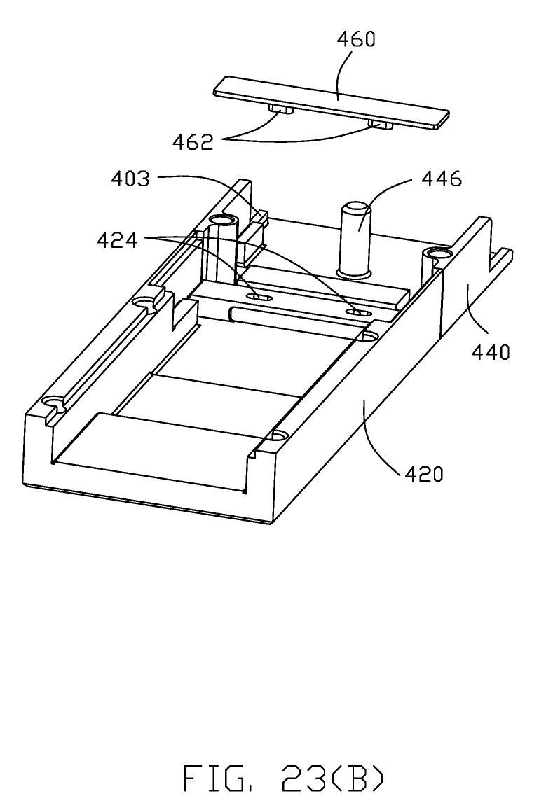

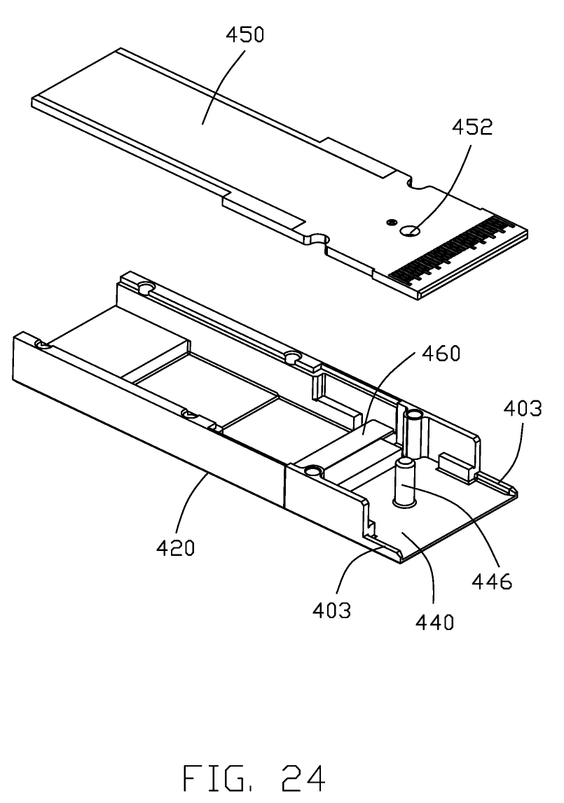

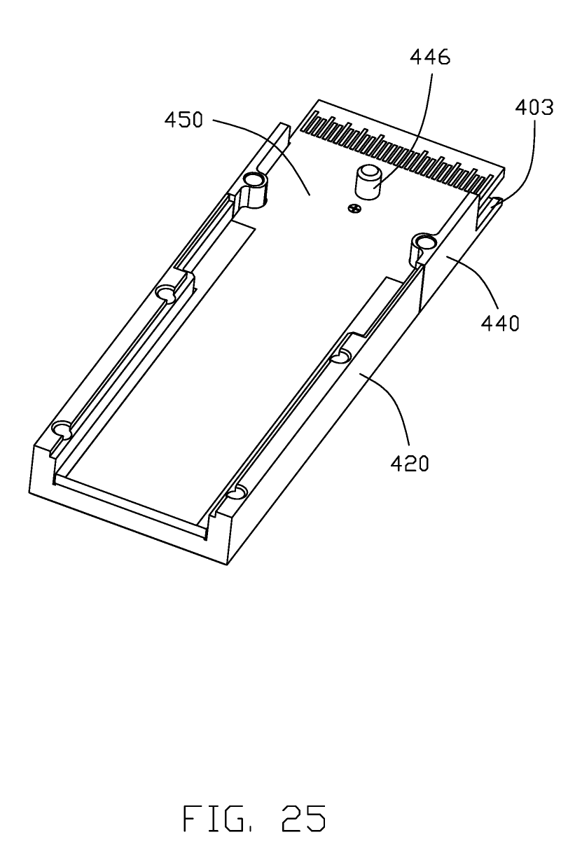

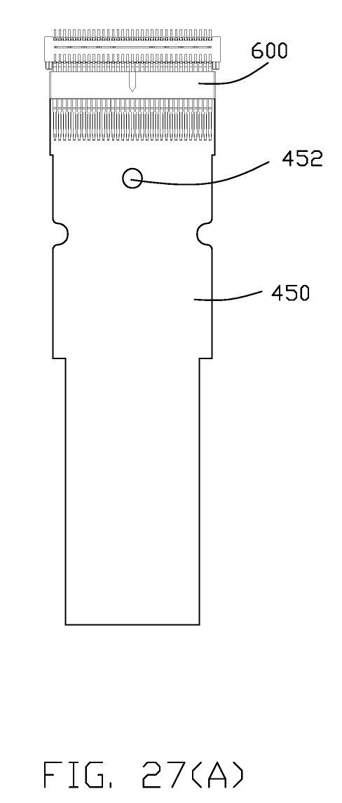

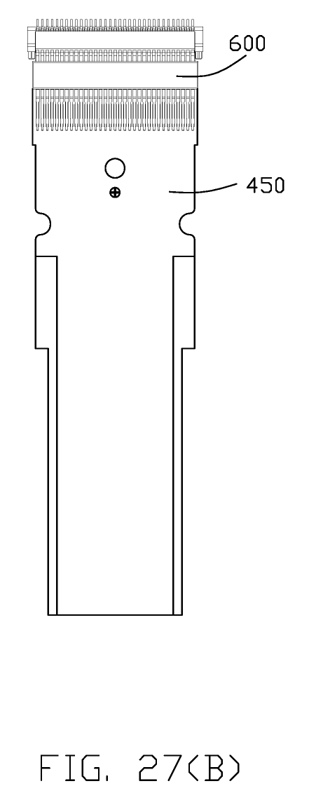

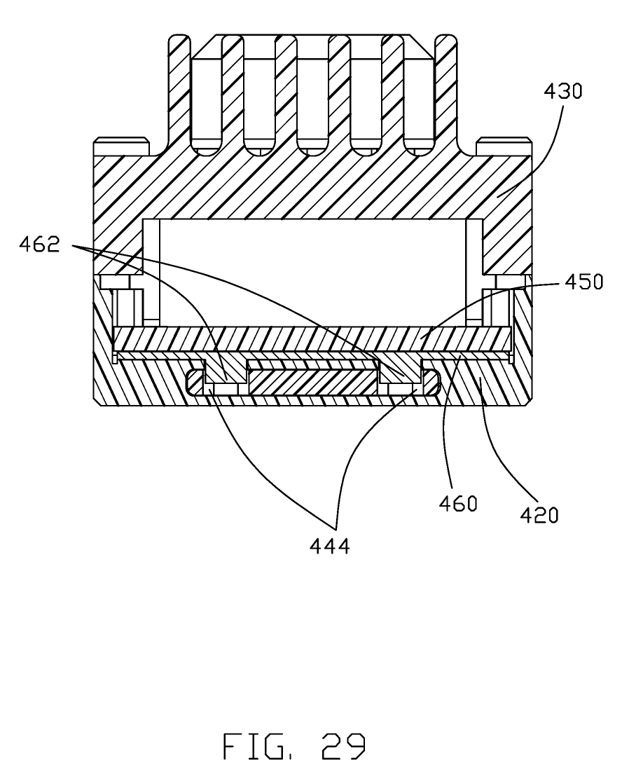

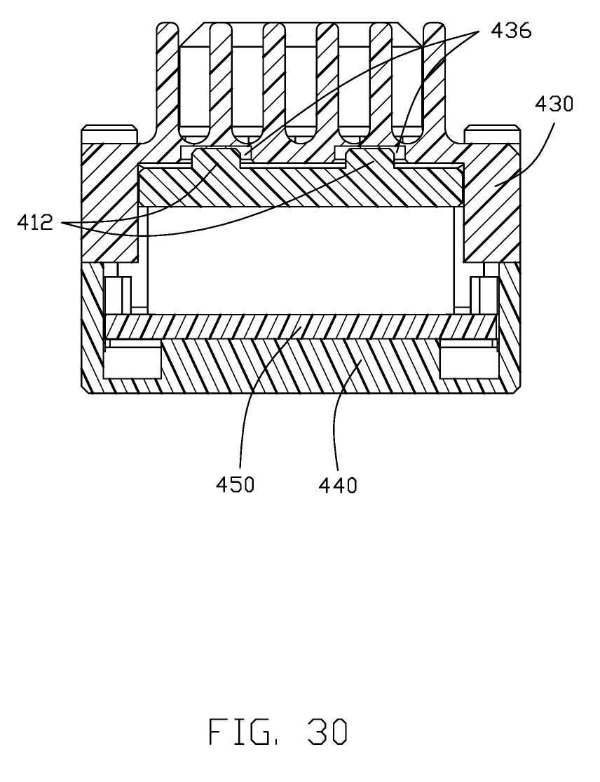

Referring to FIGS. 18-30, in the third embodiment electrical connector assembly 20 includes a plug connector 400 and a receptacle connector 600 enclosed within a metallic cage 670 and mounted upon a mother board 680. Compared with the previous design, there are some other features in the instant invention. The receptacle connector 600 comprises an insulative housing 610 having four walls 611, and defining four slots 602 formed in four corners of said insulative housing 610. The housing of the plug connector 400 includes a rear upper fixed housing 410 and a rear lower fixed housing 420 assembled with each other via the screws 490 to enclose a printed circuit board 450, and further includes a front upper floating housing 430 and a front lower floating housing 440 assembled with each other via the screws 490 wherein the rear upper fixed housing 410 forms posts 412 received within the corresponding holes 436 of the front upper floating housing 430, and similarly the rear lower fixed housing 420 forms a cavity 422 to receive a corresponding protrusion 442 of the front lower floating housing 440. Notably, the coupling between the rear upper fixed housing 410 and the front upper floating housing 430, and that between the rear lower fixed housing 420 and the front lower floating housing 440 are loose to allow a floating therebetween in the transverse direction, and understandably, another floating along the vertical direction may optionally exit, if necessary. In other words, a clearance exists between the coupling parts of the fixed housing 410, 420 and the floating housing 430, 440. In this embodiment, the upper floating housing 430 and the lower floating housing 440 are made by molded plastic and the upper fixed housing 410 and the lower fixed housing 420 are made by die cast metal wherein the upper fixed housing 410 is equipped with the heat sink structure 470. The upper floating housing 430 comprises a horizontal upper plate and a pair of upper ribs 405 for mating with corresponding slot 602. The bottom floating housing 440 comprises a horizontal lower plate and a pair of lower ribs 403 for mating with corresponding slot 602. The front upper floating housing 430 and a front lower floating housing 440 can be accurately aligned to the receptacle connector 600 by the upper ribs 405 and the lower ribs 403 mated with the corresponding slots 602, respectively.

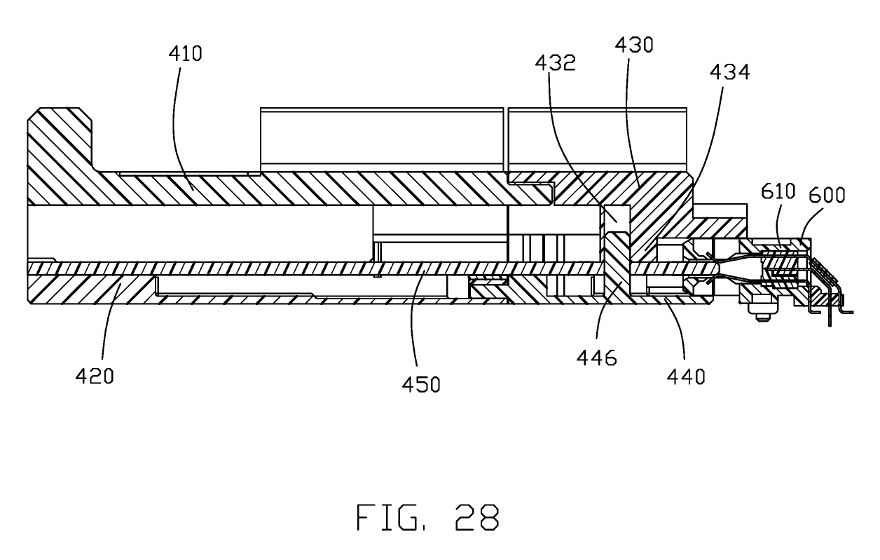

A spacer 460 has a pair of posts 462 extending downwardly through the corresponding holes 424 of the lower fixed housing 420 and the corresponding holes 444 of the lower floating housing 440 for restricting relative movement therebetween along the front-to-back direction. On the other hand, the lower floating housing 440 forms an upward post 446 extending upwardly through the corresponding hole 422 of the printed circuit board 450 into the hole 432 in the downward pole 434 of the upper floating housing 430. As shown in FIG. 28, the printed circuit board 450 is sandwiched between the upper floating housing 430 and the lower floating housing 440.

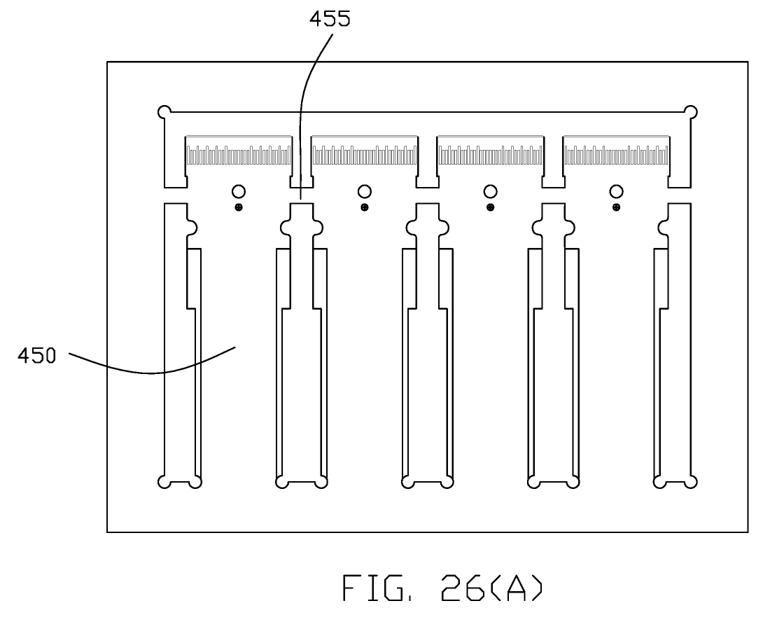

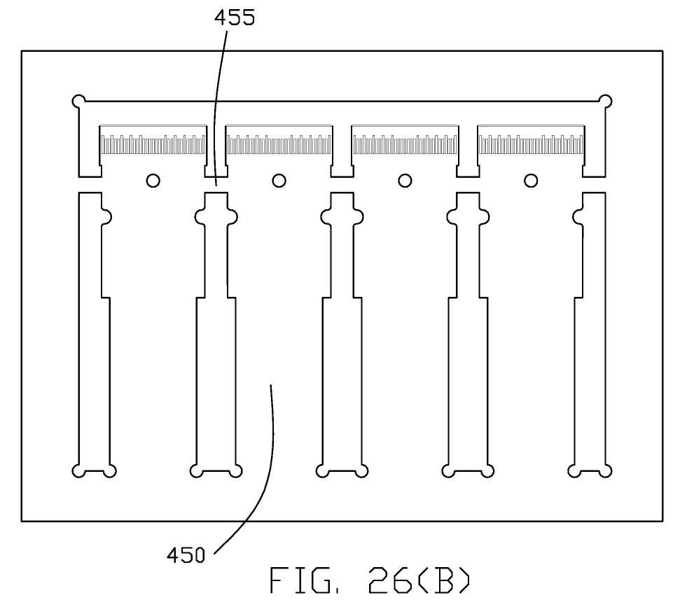

FIGS. 26(A) and 26(B) show the printed circuit board 450 is made from a large board with bridges 455 linked between every adjacent two printed circuit boards 450 for precisely forming the corresponding pads thereon. The bridges 455 keep the individual printed circuit board 450 stable during coaching. Fish mill each printed circuit board 450 mating area relative to each local fiducial.

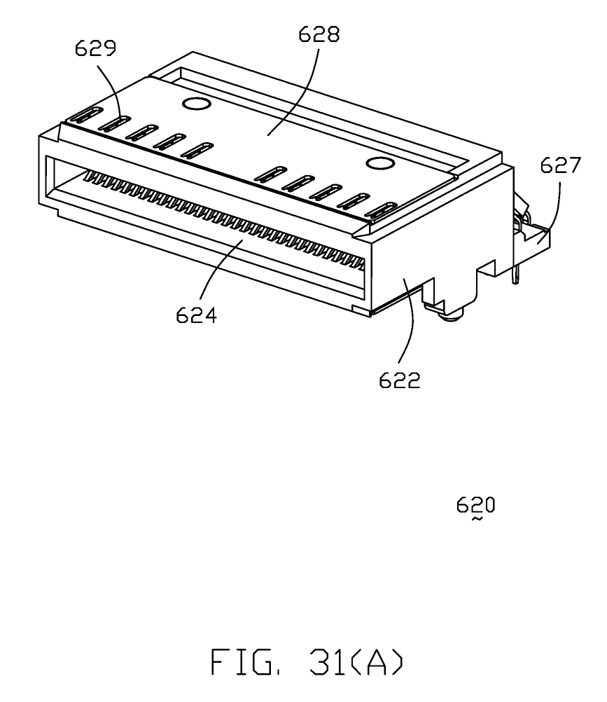

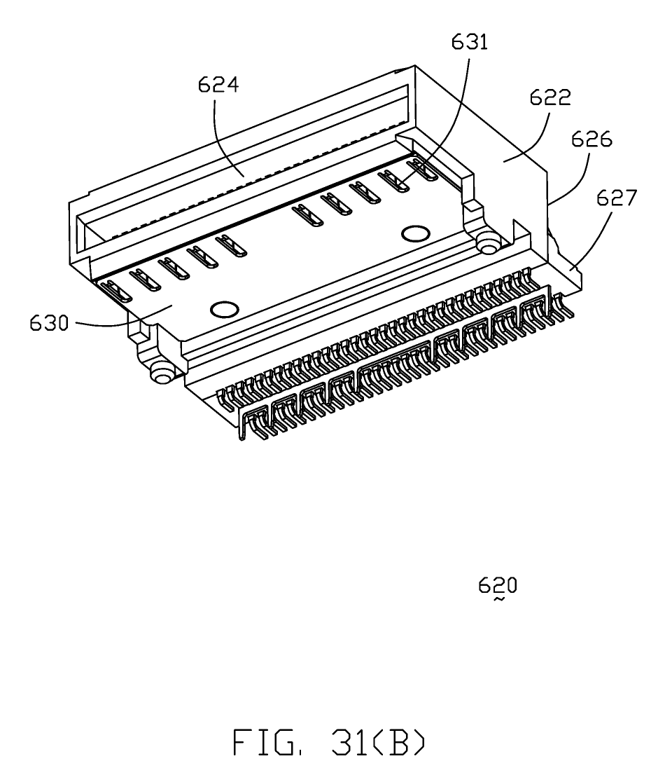

FIGS. 31(A) and 31(B) show the another embodiment of the receptacle connector 620. The receptacle connector 620 includes an insulative housing 622 with a front cavity 624 for receiving a mating tongue of a complementary plug connector, and a rear cavity 626 to receive a terminal assembly 627 therein. An upper metallic ground plate 628 with the grounding fingers 629 thereon is located upon an upper surface of the housing 622, and a lower metallic ground plat 630 with the grounding fingers 631 is located upon a bottom surface of the housing 622.

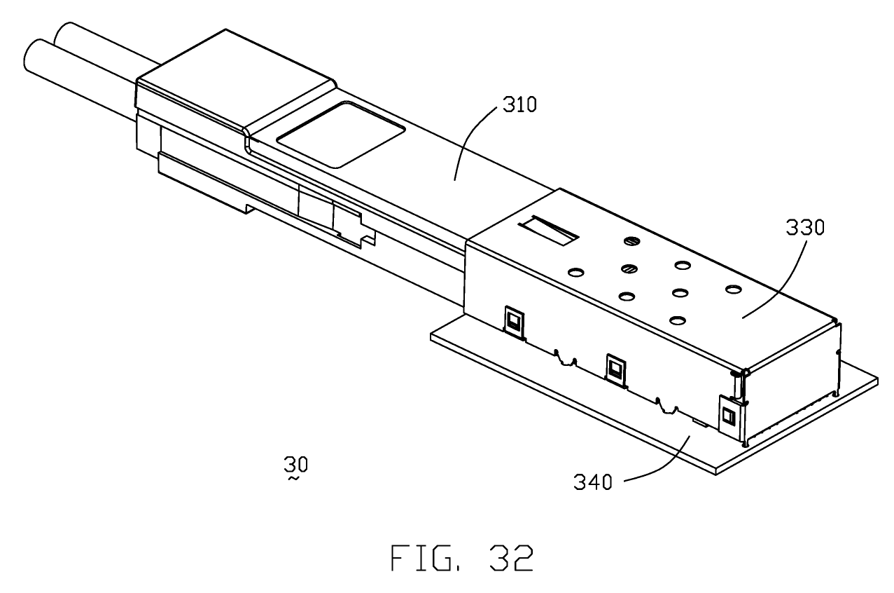

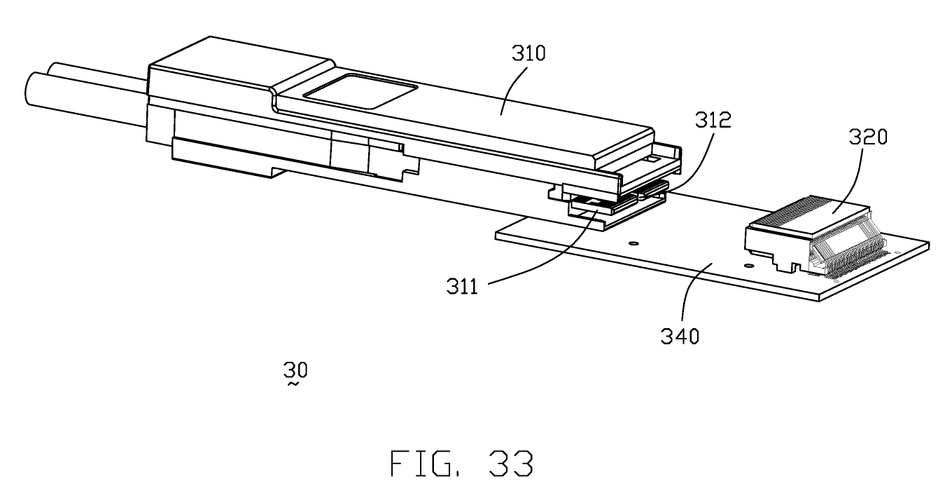

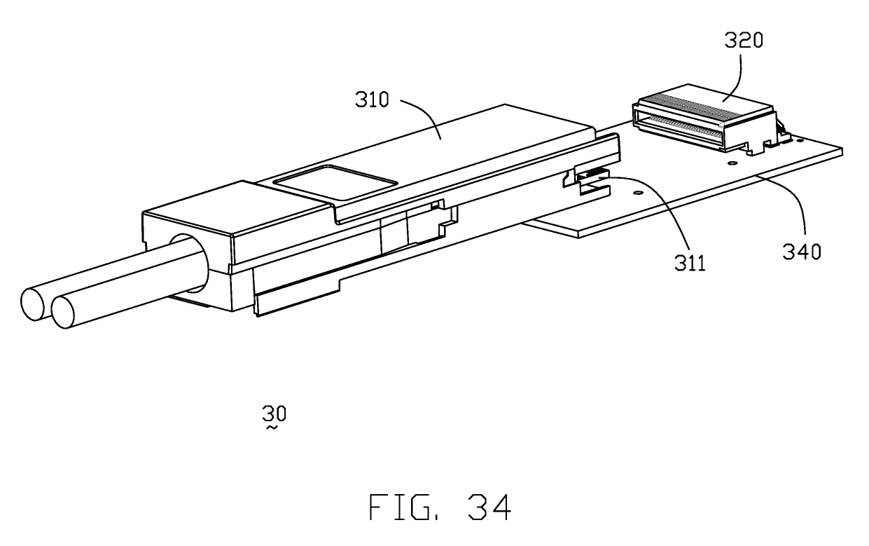

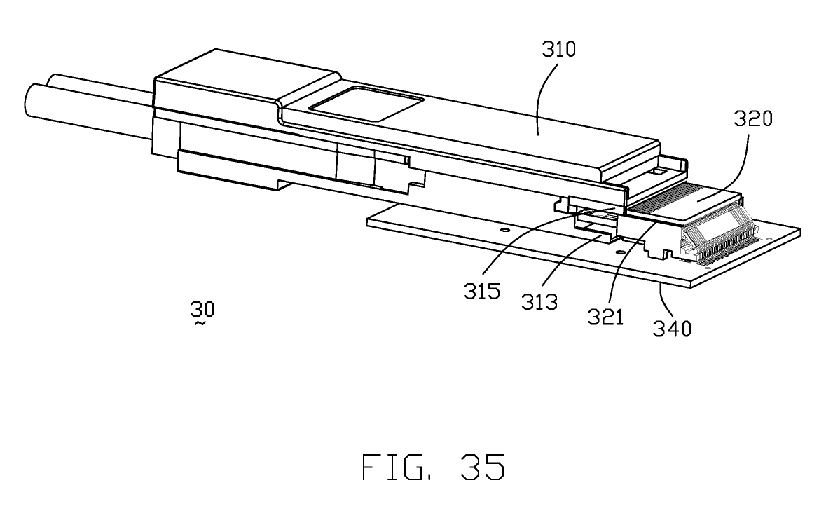

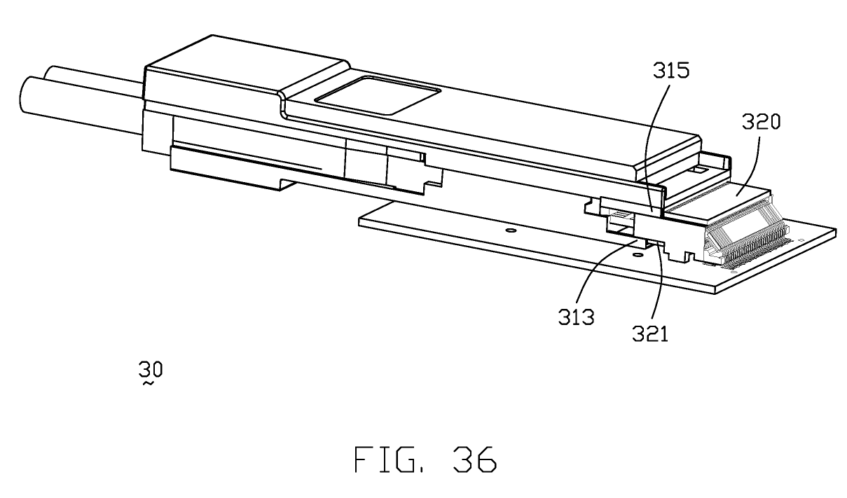

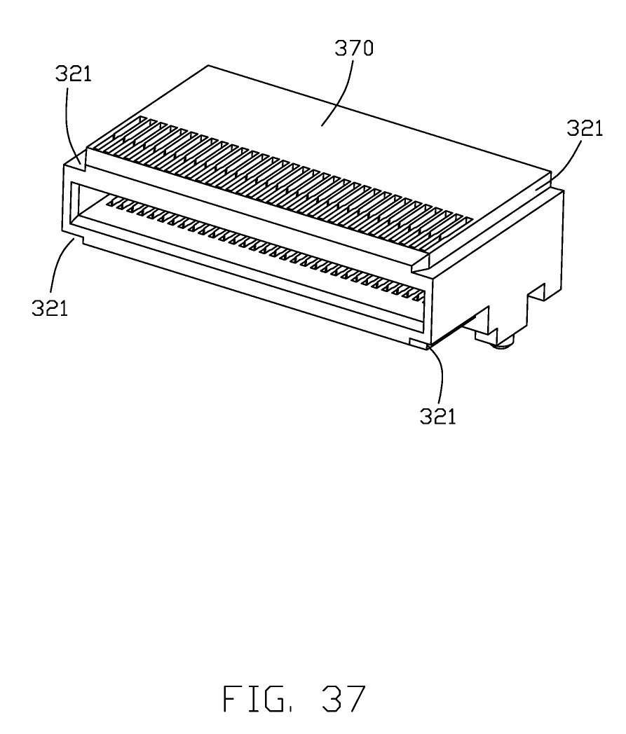

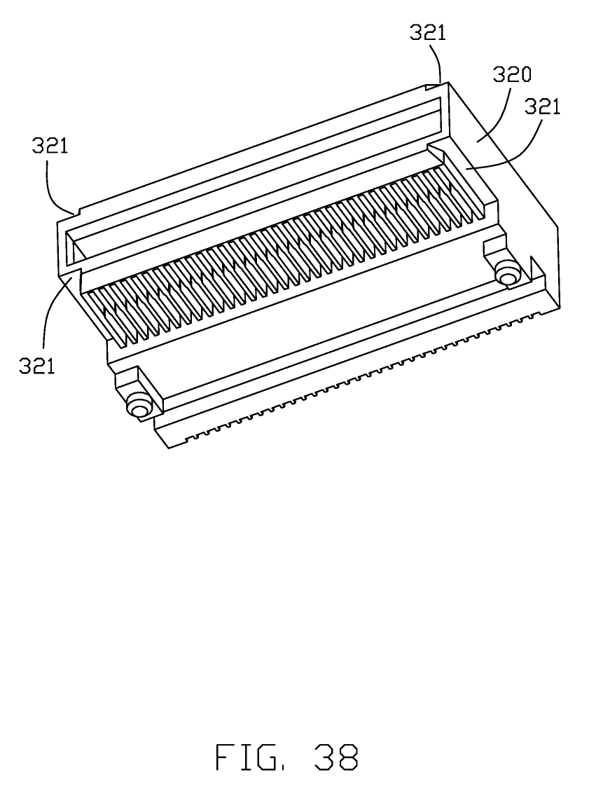

Referring to FIGS. 32 to 38, in the fourth embodiment electrical connector assembly 30 includes a plug connector 310 and a receptacle connector 320 enclosed within a metallic cage 330 and mounted upon a mother board 340. The plug connector 310 is similar with the plug cable connector 100 of the second embodiment. But this embodiment don't comprises a heat sink and an EMI shielding block. The printed circuit board 310 of the plug connector 310 defines a notch 311 which is similar with the slot 291 showing in FIG. 6(C). In FIGS. 35 and 36, when the plug connector 310 is mated with the receptacle connector 320, the ribs 315 of the upper portion is initially alignment with the corresponding slots 321 of the receptacle connector 320, and then the ribs 313 of the lower portion is final alignment with the corresponding slots 321 of the receptacle connector.

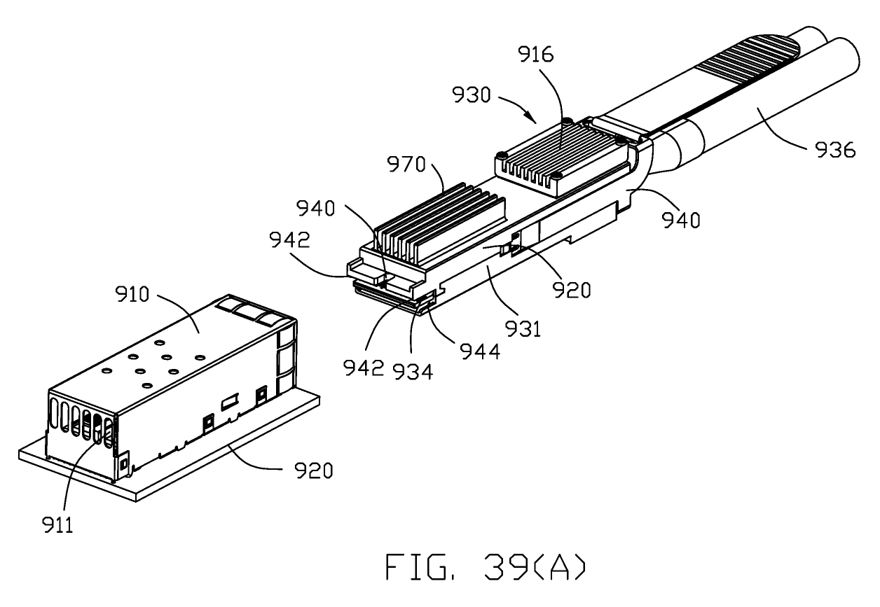

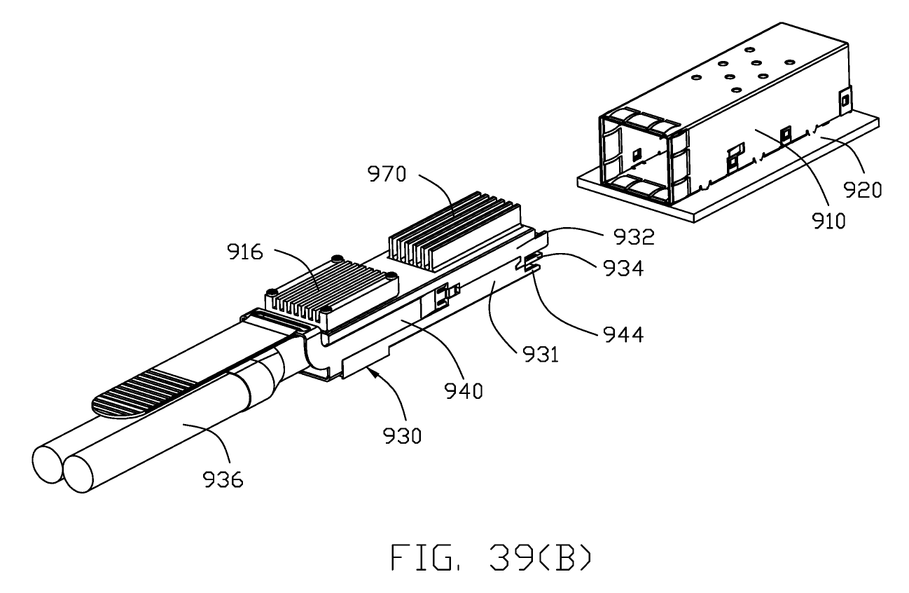

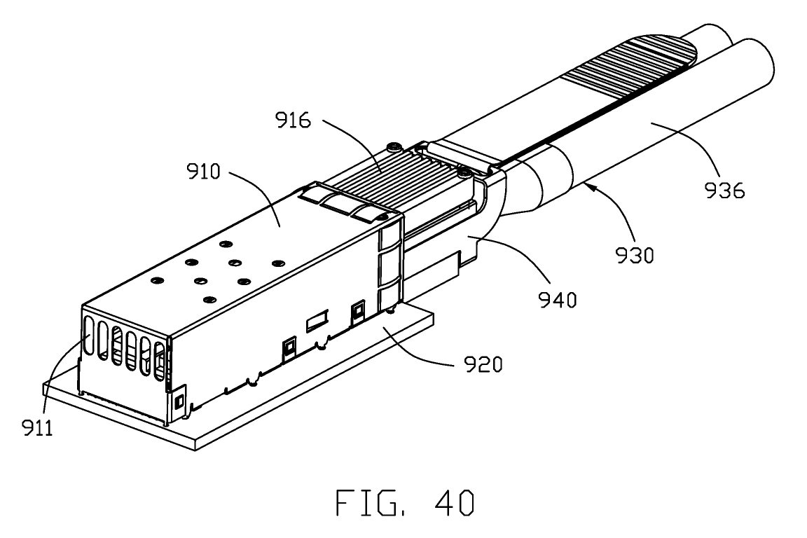

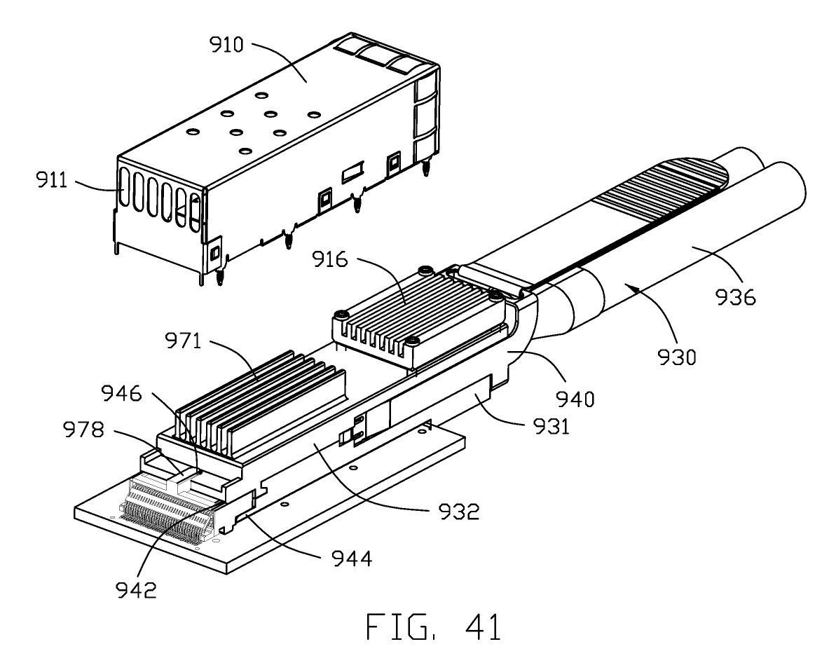

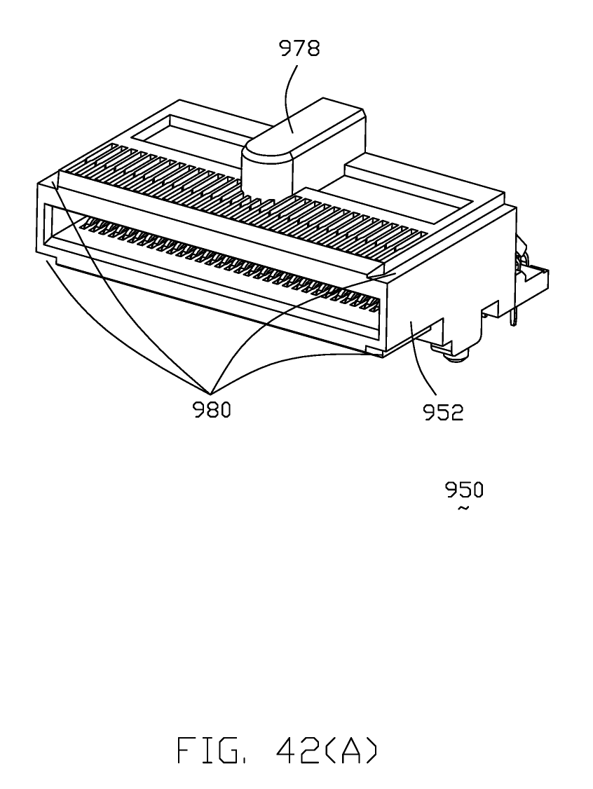

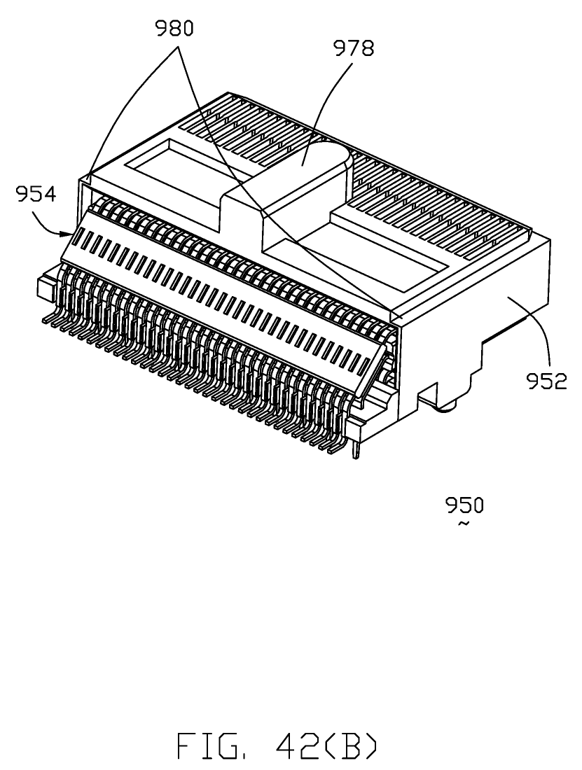

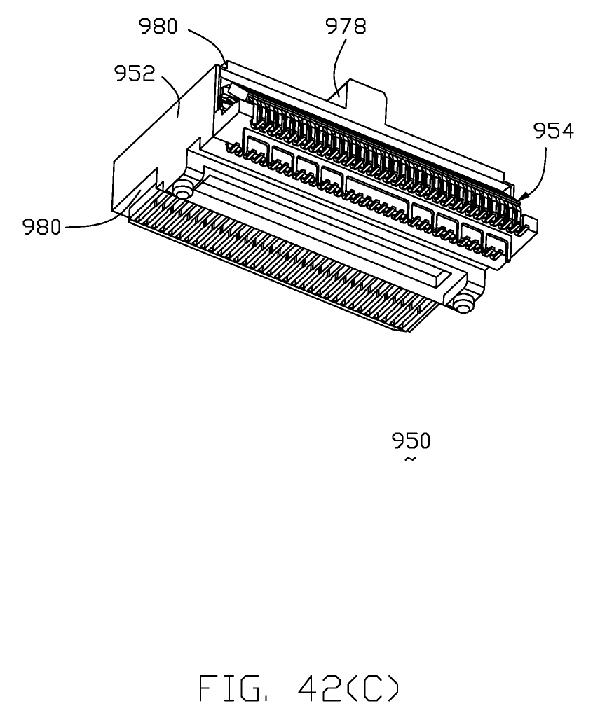

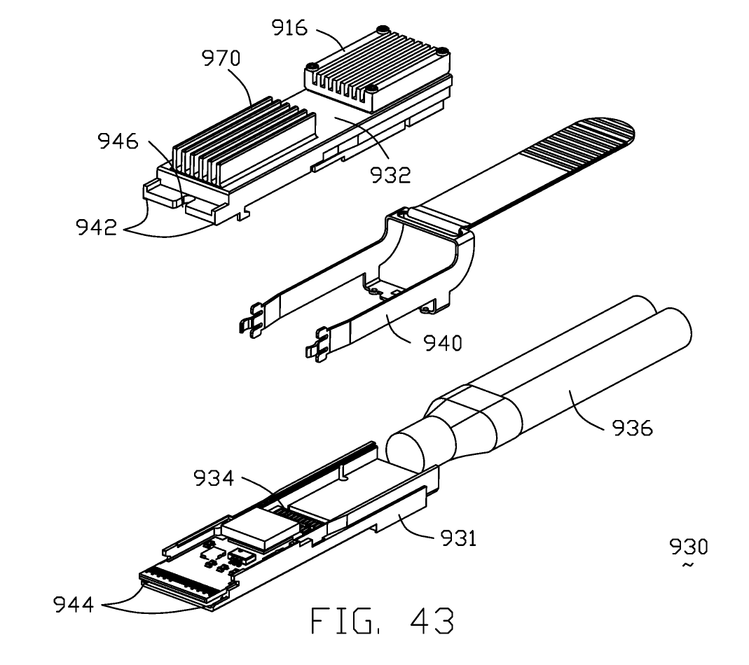

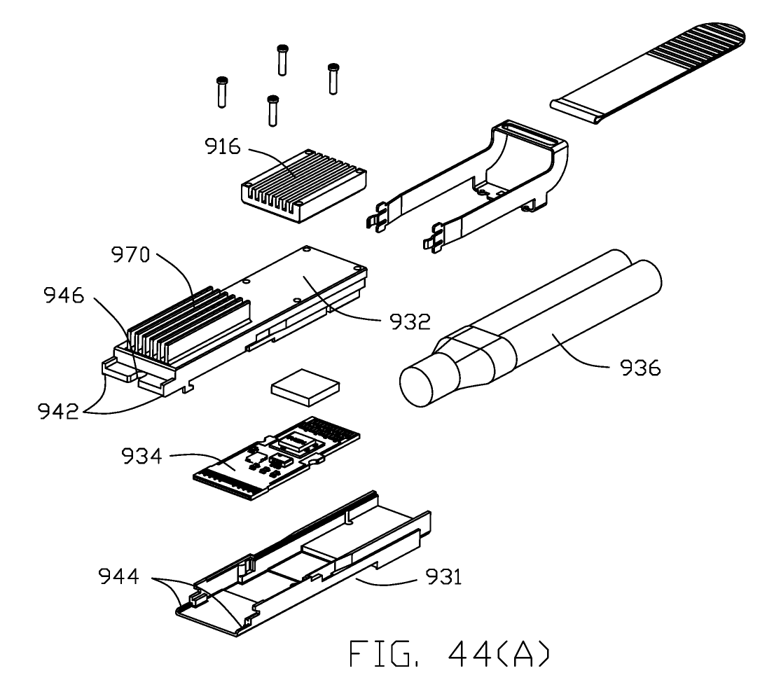

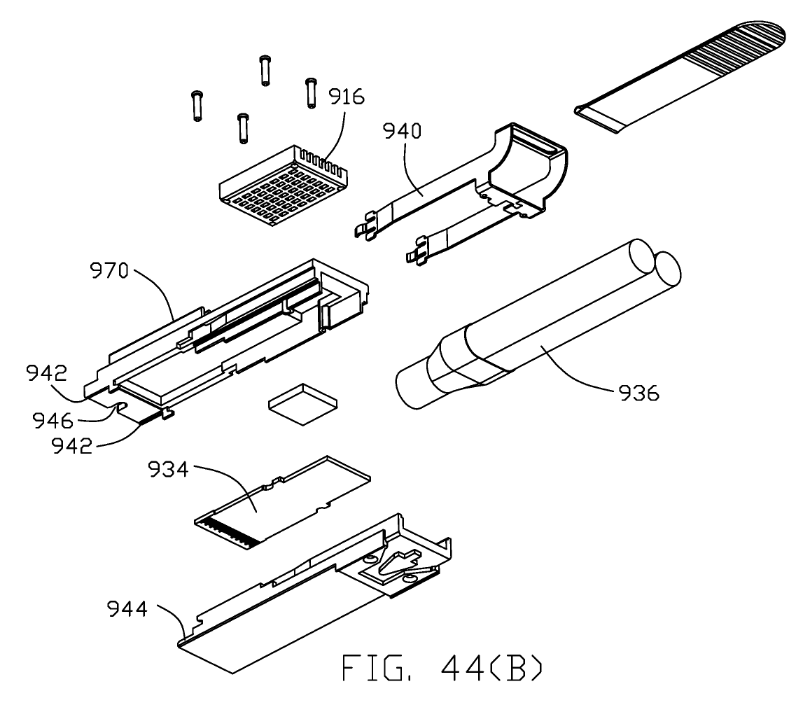

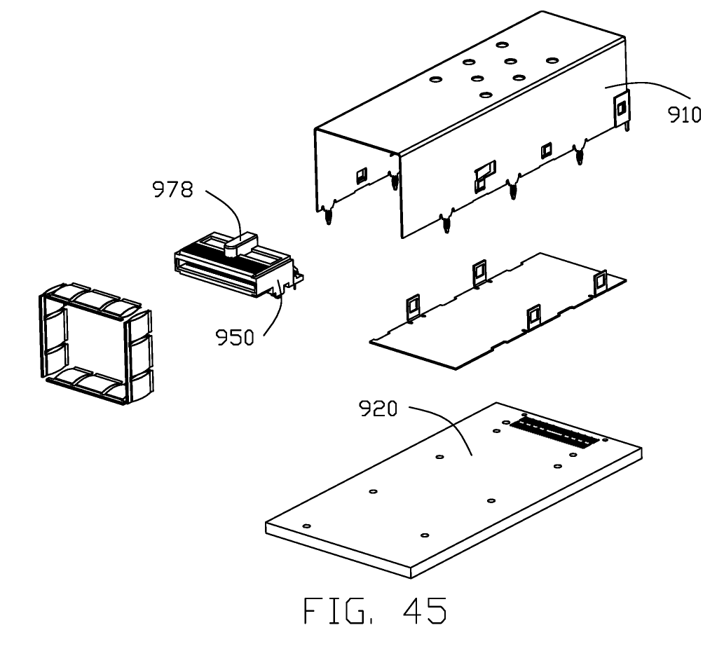

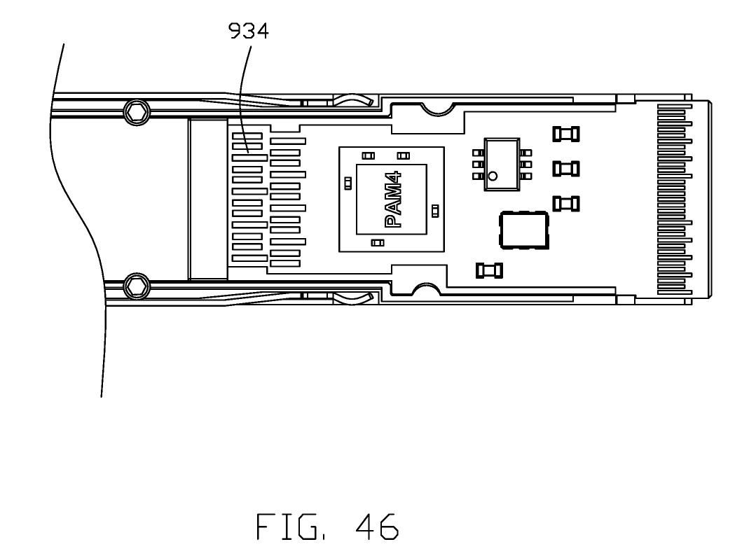

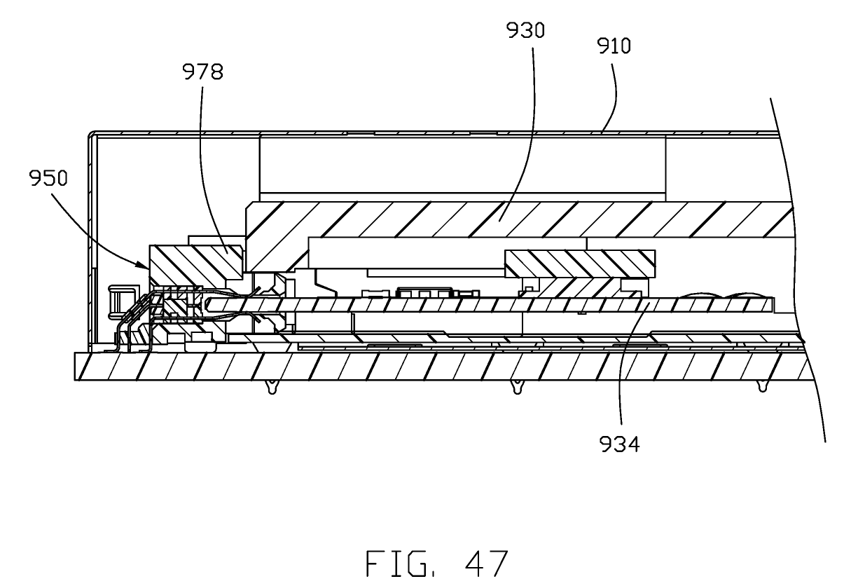

Referring to FIGS. 39(A) to 47, in the fifth embodiment electrical connector assembly 900 belonging to the so-called FP5 connector assembly which is similar to the aforementioned QSFP-DD connector assembly, including a plug connector 930 to mate with a receptacle 950 within a metallic cage 910 and mounted on a printed circuit board 920. It is noted that even though the mating port between the plug connector 930 and the receptacle 950 is somewhat similar to that between the QSFP-DD plug connector and the QSFP-DD receptacle, the cage 910 is relatively higher than the QSFP-DD cage. It is because in the QSFP-DD connector assembly the heat sink is attached upon the top cover of the plug connector after the plug connector is assembled into the cage while in the FP5 connector assembly 900 the heat sink 970 and the EMI shielding block 916 is attached or unitarily formed upon the top cover of the plug connector 930 and commonly inserted into the cage 910 with the top cover 932. Similar to the QSFP-DD plug connector, the plug connector 930 includes a metallic base 931 and a metallic top cover 932 commonly defining a receiving cavity to receive a paddle card 934 therein. A cable 936 includes a plurality of wires (not shown) soldered upon the paddle card 934. An actuator 940 is movable along the front-to-back direction for releasing the plug connector 930 from the cage 910. As mentioned in the previous provisional application, the top cover 932 forms a pair of alignment ribs 942, and the base 931 forms a pair of alignment ribs 944 so as to received within the corresponding slots 980 in the receptacle 950 while being stopped by the QSFP-DD receptacle for preventing mis-mating. The receptacle 950 is similar to what is disclosed in the previously filed provisional application and includes an insulative housing 952 enclosing a terminal module sub-assembly 954. The housing 952 further forms a protrusion 978 to be received within the notch 946 in the top cover 932. Understandably, because of the protrusion 978 on the FP5 receptacle connector 950, the QSFP-DD plug connector can not mate with the FP5 receptacle 950; in opposite, because of alignment ribs 942, 944 of the FP5 plug connector 930, the QSFP-DD receptacle connector can not mate with the FP5 plug connector 930. Without such foolproof arrangement, the QSFP-DD and the FP5 may mistakenly interchangeable with each other due to the similar interface therebetween. The metallic cage 910 defines a plurality of through holes 911 in communication with the slots formed on the sink 970 and the EMI shielding block 916 that forms air channels for heat sink.

What is claimed is:

1. An electrical connector assembly comprising:
a receptacle connector comprising:
an insulative housing; and
a plurality of contacts received in the housing; and
a plug connector for being mated with the receptacle connector, comprising:
an enclosure; and
a printed circuit board enclosed in the enclosure with an end for being inserted into the insulative housing to mate with the contacts; and
wherein at least one pair of slots are formed on one of the receptacle and the plug connector, and at least a corresponding pair of ribs are formed on the other to mate with the at least one pair of slots for not only providing an anti-mismating function but also a restriction function for holding the plug connector in position with respective to the receptacle.

2. The electrical connector assembly as claimed in claim 1, wherein a plurality of pads are formed on a front region of the printed circuit board in one row with a 0.5 mm pitch.

3. The electrical connector assembly as claimed in claim 2, wherein the printed circuit board defines a pair of fiducial positions for easy reference to assure the precise position of the conductive pads.

4. The electrical connector assembly as claimed in claim 1, wherein the enclosure comprises an additional plate, and the at least pair of ribs formed on the additional plate.

5. The electrical connector assembly as claimed in claim 1, wherein the printed circuit board of the plug connector forms a slot and the corresponding receptacle connector forms a ribbed structure in the mating cavity to mate therewith.

6. The electrical connector assembly as claimed in claim 1, wherein the enclosure comprises a horizontal upper plate, a pair of the ribs formed at two opposite lateral sides of the horizontal upper plate, the insulative housing having four walls to define a rectangular mating opening, a pair of the slots formed on corresponding two corners of said insulative housing around said rectangular mating opening to receive said ribs of the horizontal upper plate, respectively.

7. The electrical connector assembly as claimed in claim 6, wherein the enclosure comprises a horizontal lower plate, the printed circuit board located between the horizontal upper plate and the horizontal lower plate in a vertical direction, a pair of the ribs formed at two opposite lateral sides of the horizontal lower plate, a pair of the slots formed in corresponding corners of said insulative housing around said rectangular mating opening to receive said two pairs of ribs of the horizontal lower plate, respectively.

8. The electrical connector assembly as claimed in claim 7, wherein the enclosure comprises a die cast rear housing linked to a molded front housing floatable with regard to the rear housing in at least a transverse direction.

9. The electrical connector assembly as claimed in claim 8, wherein the molded front housing comprises a front upper floating housing and a front lower floating housing, the horizontal upper plate formed on the front upper floating housing, and the horizontal lower plat formed on the front lower floating housing.

10. The electrical connector assembly as claimed in claim 9, wherein the enclosure comprises a spacer mated with the lower floating housing and the die cast rear housing to restricting relative movement therebetween along the front-to-back direction.

11. The electrical connector assembly as claimed in claim 6, wherein the horizontal upper plate further forms a notch, and the insulative housing further comprises a protrusion to be received within the notch.

12. The electrical connector assembly as claimed in claim 6, wherein the receptacle connector further comprises a metallic cage, the insulative housing enclosed in the metallic cage, the plug connector comprising a heat sink located on the enclosure, and a EMI shielding block located on the enclosure and behind the heat sink for radiation absorption.

13. The electrical connector assembly as claimed in claim 12, wherein the EMI shielding block defines a plurality of passageways extending through the EMI shielding block in a front-to-back direction.

14. The electrical connector assembly as claimed in claim 12, wherein the EMI shielding block defines a plurality of through holes extend through the EMI shielding block in the vertical direction to allow air passing for heat transfer.

15. The electrical connector assembly as claimed in claim 12, wherein the enclosure forms an empty column extending through the printed circuit board to guide external air into an interior of the enclosure where the heat sink downwardly faces.

16. The electrical connector assembly as claimed in claim 1, wherein the receptacle connector comprises a terminal module received within the housing, said terminal module including an upper terminal module, a lower terminal module commonly sandwiching a shielding plate module therebetween.

17. An electrical connector assembly comprising:
a first electrical connector assembly including a first plug connector and a first receptacle connector adapted to be mated with each other, the first plug connector including a first cover with at least two opposite first plates defining a first receiving space with therebetween a first mating tongue in a vertical direction, the first receptacle connector including a first frame housing with therein a first mating cavity adapted to receive said first mating tongue therein; and
a second electrical connector assembly including a second plug connector and a second receptacle connector adapted to be mated with each other, the second plug connector including a second cover with at least two opposite second plates defining a second receiving space with therebetween a second mating tongue in the vertical direction, the second receptacle connector including a second frame housing with therein a second mating cavity to receive the second mating tongue therein, the first receiving space being similar to the second receiving space, the first mating cavity being similar to the second mating cavity; wherein
in the second connector assembly, the second cover of the second plug connector forms at least one rib on at least one of said two opposite second plates and one notch in at least one of said two opposite second plates, and the second frame housing of the second receptacle connector forms at least one slot adapted to receive said rib, and one protrusion adapted to be received within said notch during when said second plug connector and the second receptacle connector are mated with each other while the protrusion of the second receptacle connector prevents the first plug connector from being incorrectly mated therewith, and the rib of the second plug connector prevents the first receptacle connector form being incorrectly mated therewith.
